(19) United States
(12) Patent Application Publication
(10) Pub. No.: US 2014/0278730 A1
(43) Pub. Date: Sep. 18, 2014

(54) VENDOR MANAGEMENT SYSTEM AND METHOD FOR VENDOR RISK PROFILE AND RISK RELATIONSHIP GENERATION

(71) Applicant: MEMORIAL HEALTHCARE SYSTEM, (US)

(72) Inventors: Matthew MUHART, Miramar, FL (US); Joseph M. PALMAR, Miami, FL (US); James Thomas GREEN, Leesburg, VA (US); Gregg John WRIGHT, Ashburn, VA (US); Suresh Venkatraya SHENOY, Great Falls, VA (US)

(73) Assignee: MEMORIAL HEALTHCARE SYSTEM, Hollywood, FL (US)

(21) Appl. No.: 13/828,106

(22) Filed: Mar. 14, 2013

(51) Int. Cl. G06Q 10/06

(52) U.S. Cl. CPC G06Q 10/0635
USPC 705/7.28

(57) ABSTRACT

A vendor management system for calculating risks associated with registered vendors, the system including a processing device including a hardware processor configured to operate a risk calculation module to perform a risk analysis associated with a vendor of the registered vendors, a user terminal for accessing the processing device by a user, the user terminal configured to generate a user interface for the user to select a vendor from a list of registered vendors and to display a result of a risk analysis including a risk score performed by the risk calculation module; and a database access device configured to access data on the registered vendors including an access to a first database entry storing a vendor profile information including risk criteria associated with vendors, a second database entry storing personnel information of the vendors including information on at least one of employees and directors; and a third database entry storing weight factors associated with the risk criteria.

### TECHNICAL FIELD OF THE INVENTION

The present invention relates generally to systems, methods, and devices for automatically verifying and managing risks that are associated with vendors for managing relationships with vendors.

### BACKGROUND

Many businesses, companies, government entities, non-profit and non-governmental organizations, and international organizations increasingly need to rely on third parties as service and product providers for creating, running, operating, and maintaining critical business systems and processes. However, this reliance on these third parties exposes the businesses and their clients to greater risks from business disruptions due to delivery delays, operational failures, lawsuits, defaults, quality issues, bankruptcy. Moreover, businesses tend to have a large number of such third-party vendors for different products and services which further increases the business risk. As a consequence of business disruptions that result from any problems with the third parties, business can lose clients, lose entire business relationships, be subject to criminal prosecution, be subject to civil lawsuits, and their reputation towards clients and investors can be impacted. Challenging economic conditions compound these risks as clients and third party suppliers maneuver through tightening budgets and directives to reduce costs, such as operational expenses.

An additional factor that can cause business disruptions from third-party vendors occurs when the third-parties engage into fraudulent and illegal business behavior, such as bid rigging, price fixing, market division, kickbacks, overbilling, shrinkage. Typical organizations lose about 5% of their annual revenue due to fraud, for example fraudulent business activities of their third-party vendors. Applied to the estimated 2009 Gross World Product, this figure translates into a potential total fraud loss of more than $2.9 Trillion. Moreover, a study has shown that the median loss caused by occupational fraud cases was $160 k, and nearly one quarter of the losses caused by fraud was at least $1M. In addition, it has been estimated that businesses in the United States lose an estimated $1.5 Billion in revenue per year due to poor vendor risk management, assessment, and prevention. Without a risk management solution for analyzing third-party vendors that is comprehensive and continuous, a business leaves itself open and vulnerable to business losses and interruption.

Business have adopted different schemes to detect fraud and the associated business risks, based on careful management review of the third-party vendor, tips from investigators and experts in the business field, internal and external audits by auditing companies. However, most of these conventional solutions fail to take into account various risk-related and vendor-specific databases and information sources that provide viable information to estimate certain risk that are typical for different categories of third-party vendors. Also, many of the conventional solutions fail to provide modular and flexible solutions that allow to integrate external information technology security access tools, and identity verification systems. Moreover, conventional solutions also fail to provide certain automatic credentialing tools that can help preventing corruption through relationship discovery. Accordingly, despite the presence of some solutions in the field of managing third-party vendors, still further solutions are desired.

### SUMMARY

In one aspect of the present invention, a vendor management system for calculating risks associated with registered vendors is provided. Preferably, the vendor management system includes a processing device including at least one hardware processor configured to operate a risk calculation module to perform a risk analysis associated with a vendor of the registered vendors, and a user terminal for accessing the processing device by a user, the user terminal configured to generate a user interface for the user to select a vendor from a list of registered vendors and to display a result of a risk analysis including a risk score performed by the risk calculation module. Moreover, preferably the vendor management system further includes a database access device configured to access data on the registered vendors including an access to a first database entry storing a vendor profile information including risk criteria associated with vendors, a second database entry storing personnel information of the vendors including information on at least one of employees and directors, and a third database entry storing weight factors associated with the risk criteria.

According to another aspect of the present invention, a vendor management method for calculating risks associated with registered vendors is provided. The vendor management method preferably including a step of selecting a vendor from a list of the registered vendors via a user terminal, and accessing data on the registered vendors by a data base accessing device, the accessing including access to a first database entry storing a vendor profile information including risk criteria associated with vendors, a second database entry storing personnel information of the vendors including information on at least one of employees and directors, and a third database entry storing weight factors associated with the risk criteria. Moreover, the vendor management method preferably further comprises the steps of performing a risk analysis associated with the selected vendor based on the data of said step of accessing with a risk calculation module that is operated on a processing device including at least one hardware processor, to generate a risk score, displaying a result of the risk analysis including the risk score associated with the selected vendor.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 represents a schematic overview of the vendor managements system and the relationships to entities that will directly or indirectly use the system;

FIG. 2 represents a schematic overview of the vendor management system showing different software layers according to an embodiment;

FIG. 3 represents a schematic representation of the logical view of the functions operated by the vendor management system according to another embodiment;

FIG. 4 represents a schematic overview of a hardware system operating the vendor management system according to still another embodiment;

FIGS. 5A and 5B represent schematic representations of processes performed by registered and non-registered vendors of the vendor management system according to yet another embodiment;

FIG. 5C shows an exemplary screenshot of a graphical user interface for a vendor to create an account according to a further embodiment;

FIG. 6 represents a schematic view of the web services module according to yet another embodiment;

FIG. 7 represents a schematic view of the registration module according to an another embodiment of the present invention;

FIG. 8 represents a schematic representation of processes performed by users of the vendor management system according to an additional embodiment;

FIGS. 9A and 9B represent an exemplary vendor search form for users to search for registered vendors according to still another embodiment;

FIG. 10 represents a graph showing a timely evolution of a risk score;

FIG. 11 represents an exemplary search result of vendors presented in a list;

FIG. 12 represents a schematic representation of processes performed by the risk module according to another embodiment;

FIG. 13 shows an exemplary relationship diagram showing discovered relationships between registered vendors;

FIG. 14 shows an another exemplary relationship diagram showing discovered relationships of owners between registered vendors;

FIG. 15 shows another exemplary relationship diagram showing discovered proximity issues between registered vendors; and

FIGS. 16A and 16B represent an exemplary executive summary report associated with a registered vendor.

Herein, identical reference numerals are used, where possible, to designate identical elements that are common to the figures. Also, the images in the drawings are simplified for illustration purposes and may not be depicted to scale.

### DETAILED DESCRIPTION OF THE SEVERAL EMBODIMENTS

FIG. 1 represents a schematic overview of the vendor management system 1 according to one embodiment of the present invention, and the entities related to the vendor management system 1, including users U₁-U₂ that access vendor management system 1 with the intent to evaluate one or more credentialed registered vendors RV₁-RV₄ to be able to gather information on the risk to engage in a business relationship with vendors RV₁-RV₄. Vendor management system 1 can be a computer system that can be accessed by user U and vendors RV₁-RV₄ via a standard web browser, application software, or a dedicated terminal with fixed firmware via the Internet. Typically, vendors RV₁-RV₄ are evaluated for risk with the goal that they provide services or products to users U₁-U₂, and users U₁-U₂ intend to establish a contractual relationship with them. Users U₁-U₂ can be entities that have one or more owners OW, employees E and officers O that are part of the operations of the users U₁-U₂, and a board of directors B or another type of governing body consisting of individuals that can be identified and listed at vendor management system 1. Vendor management system 1 can be operated and maintained by an operator OP that could be a registered vendor himself offering services and products to a user, in that case considered an operating vendor, and operator OP can have officers O, employees E, board B, and owners OW.

Also, vendors RV₁-RV₄ may also have employees E, officers O, board B, and owners OW. As symbolized in FIG. 1, registered vendors RV, and RV₂ may be owned by the same owner OW. Moreover, vendor management system 1 can also be accessed by an administrator AD that can be an employee of operator OP, or a separate entity, for example one that has been contracted for administering the registrations of the vendors RV₁ and RV₂. Also, vendor management system 1 can also be accesses by a supervisor SU for reviewing information, for example vendor risk reports, for updating software and hardware elements, for providing support to users U₁-U₂ and vendors RV₁ to RV₄ for using system 1, and an analyst AN that can have access to system 1 to manage access rights and data input of users U₁-U₂, manage vendor records, and change functionalities and parameters of the risk calculation. Moreover, a potential vendor PV can access system 1 with the goal to create an account for PV, register as a registered vendor RV₁-RV₄, and being released by a supervisor SU for automatic credentialing by users U₁-U₂. In the example discussed above and throughout this document, for simplification purposes, only four (4) vendors RV₁-RV₄, two (2) users U₁-U₂, and one operator OP are referred to, however the invention is not limited to these quantities, and many more vendors, users, and operators can be managed by system 1.

Vendor management system 1 can be used in the healthcare industry, typically for hospitals that are in the process of choosing vendors, such as health care providers as vendors that employ physicians that will offer their services to the hospital, but also for any services or products that the hospital needs, such as but not limited to medical supply vendors, cleaning services, hospital furniture, pluming and sewage services. Because the health, safety and well-being of a large number of patients can be at stake if improper vendors are chosen, hospitals are particularly vulnerable to poor vendor decisions. In such a case, user U would be a hospital that is using system 1 to verify the risk of different health care providers as registered vendors RV₁ to RV₄, and the different physicians of the vendors being employees E. Operator O can be a healthcare provider itself, or an association of healthcare providers that wants to offer system 1 to potential customer, being users U. However, vendor managements system 1 is not limited to this application field, but can be used by any entity that wishes to perform risk analysis of a potential vendor before engaging in a business relationship. For example, user U can also be an electronic hardware manufacturing company that wishes to select component suppliers from a list of registered vendors RV₁ to RV₄, and wishes to minimize business and contractual risks when engaging into a business relationship. In such a case, operator OP could be an association of component manufacturers. As another example, user U could be telephone and data network provider, such as Verizon™, T-Mobile™, interested in evaluating service companies for maintenance of the different telecom systems.

Also, the quantity of vendors that contract with a company has increased substantially in the past years, and it is not uncommon that companies have an entire department that manages and chooses vendors. For example, American Airlines manages about 100,000 vendors, for a large diversity of services and products that are offered. In the healthcare industry, even a smaller hospital usually manages around 500-1000 vendors. These growing numbers expose the companies to tremendous risks that cannot be managed efficiently without the use of an automated vendor management and selection system. Also, because the vendors themselves can have rather complex business organizations and ownership, it is not possible to manually verify a large number of vendors for bids and potential business relationships. The proposed vendor management system proposes automatic credentialing combined with data gathering from databases over web services, and therefore makes it possible to review and analyze risks of a large number of potential vendors, commonly between 500 and 10000 vendors or more. With manual or partially automated review, it would not be cost effective to review such high quantity of potential vendors. Therefore, the present system and method provides for substantial advantages to search, analyze, and select vendors based on a comprehensive and automated risk analysis that was not possible with conventional solutions.

FIG. 2 represents a schematic overview of the vendor management system 1 showing a software layer model of the system. Different entities, such as users U₁ to U₂, registered credentialed vendors RV₁ to RV₄, non-registered potential vendors PV, access the vendor management system 1 via a web interface 2. Web interface 2 presents to PV, RV, and U different graphical user interfaces via terminals 2.1-2.3 to use the vendor management 1, for example for registering, updating information, accessing vendor status and information, and calculating risks associated to certain vendors. Next, work flow layer 3 is represented including functional elements registration 3.1, edit profile 3.2, and manage vendors 3.3. Web services layer 4 represents the access of different data resources over a web interface that can be accessed by functional elements of the work flow layer, allowing access to various external databases 4.1 to 4.4, for example data bases accessed over a web interface. Moreover, via system firewall 6, work flow layer 3 can access a data layer 5, that includes and analytical database application, for example Sequel™ database application, iBase™ database application from the I2 Group™ Inc., for capture, control, query and analyze multi-source data from the different external databases 4.1 to 4.4 and to provide uniform data resources for system, for example by storing them in proprietary databases 5.1-5.2, or to access proprietary databases 5.1-5.2 having multi-source data without passing via the web services layer 4. Databases 5.1-5.2 preferably store the information that is proprietary to the system 10 and the operator OP. The access to data layer 5 from work flow layer 3 can also be via a secured Intranet, in which data layer 5 and work flow layer 3 are located on the same network level hierarchy so that no system firewall 6 would be necessary.

FIG. 3 represents a schematic representation of the logical view of different elements or modules that represent different functions of the vendor management system 10. These elements are operated at the work flow layer 3 shown in FIG. 2. FIG. 3 shows eleven (11) different elements for vendor management system 10, but as understood by one of ordinary skill in the art, other elements providing different functions can also be part of vendor management system 10, and the eleven elements may not be and exclusive representation. Also, vendor management system 10 can also be implemented such that an individual element is implemented as two or more sub-elements, and thereby split into different sub-functions so that each sub-function is implemented as a separate element. Account module 100 is an object that provides various functions related to the accounts of users U₁-U₂ and vendors RV₁ to RV₄ for example for logging into an account of an already registered user U₁-U₂, vendors RV, to RV₄, checking access rights related to users and vendors, logging out from an account, managing the accounts, registering new accounts, changing existing accounts, deleting accounts, and also can be used to execute a procedure for generating a new password and username in a case the user has forgotten this information. Administration module 200 is an object that provides functions related to account management from an administrative side, for example providing functions to allow an administrator AD with the proper credentials to contact registered users, make changes to existing accounts, deleting accounts, updating software elements for maintenance.

The e-mail notifications module 300 is a module that allows to send e-mails from system 10 to stored e-mail addresses via the Internet. E-mail notification module 300 can be evoked to generate notification and alert e-mails. For example, notification module 300 can generate an e-mail notification to an entity of operator OP if a vendor risk status and score had been newly added by calculation request by user U, edited by an administrator AD, or automatically changed by automatic or periodic recalculating of vendor risk status and score. Also, a notification e-mail can be generated upon the creation of an account by a user U or a potential vendor PV with information that is necessary to confirm the account creation and the e-mail associated therewith, for example by an encrypted, selectable link. Also notification module 300 can be evoked to send an e-mail to a PV confirming the submission of the registration form. Moreover, notification module 300 can generate reminder e-mails to registered vendors notifying them of an expiration date, and can send payment notification e-mails including links to payment websites. Also, notification module can generate email notifications to provide for an executive summary report 750 to supervisor SU, and to analyst AN on expiring vendors. Executive summary report 750 includes summarized information on risks associated to vendor RV₁ to RV₄. However, it is also possible that supervisor SU or analyst AN use e-mail notifications module to generate periodical update or information e-mails to vendors. Table 1 summarizes these e-mail notifications that can be generated by e-mail notifications module 300.

TABLE I

| | | Ana- | Super- | | Admin- | |
|---|---|---|---|---|---|---|
| | | lyst | visor | | istra- | Ven- |
| No. | Email Notification | AN | SP | User | tor AD | dor |
| 1 | Account Creation | | | | | X |
| 2 | Daily Vendor Activity | X | X | X | | |
| | Report (Vendors | | | | | |
| | Registered, Vendors | | | | | |
| | Credentialed, Risk | | | | | |
| | Status Modified, | | | | | |
| | Credentialed Approval | | | | | |
| | Status) | | | | | |
| 3 | Confirming Vendor | | | | | X |
| | Registration submission | | | | | |
| 4 | Expiration Date of Regis- | | | | | X |
| | tration in 90, 60, 30 days | | | | | |
| 5 | Credential Expiring | X | | | | |
| | Vendor Next 30 days | | | | | |
| 6 | Executive vendor report | | X | | | |
| | to view | | | | | |
| 7 | Daily Audit Report | X | X | | | |

User dashboard module 400 is an object provides functions to a registered and logged-on users via a real-time user interface that can show graphical representations, tables and data on vendors and the risk associated with them, as well as historical graphs and future trends. The graphical user interface can be configured such that it is displayable by an application software, a web browser, or a dedicated firmware or operating system for accessing vendor management system 10. For example, user dashboard 400 can provide functions to perform searches by a search module to search for vendors based on different criteria, allows generating tables and graphs with search results, provides for credential reports, and reports on workflows of vendors, for example by using the iBase™ application 5.1 of the data layer 5 for accessing and storing data in the proprietary databases 5.1, 5.2.

Next, registration module 500 is an object that provides functions to vendors PV for registering their business, company or organization with the vendor management system 10 for being registered and released for searching and automated credentialing, and also provides for functions for users U₁ to U₂ to register for allowing them to search and analyze risk of registered vendors RV₁-RV₄. Registration module 500 provides functions to provide a vendor with terms of use, for example by a graphical user interface or per e-mail notification, provides for functions for entering business information, people information, address information, diversity information, references for the vendors, digital signatures, payment information, and other information. Also, registration module 500 provided for functions that allow users U₁ to U₂ to register for using system 10 by entering information that identifies their business and a contact person with an e-mail address. This information can be stored in the proprietary databases located at the data layer 5.

Next, the reporting module 600 provides functions for the vendor management system 10 that can generate reports based on data from databases 50-52 and data from different external web resources. For this purpose, reporting module 600 will be able to access the enterprise resource planning (ERP) systems of operator OP of vendor management system 10, such as but not limited to Lawson™, SAP™, PeopleSoft™, to take advantage of the reporting standards and procedures defined by the existing ERP system. For example, if Lawson™ is the ERP system of operator OP, it is possible to access data from this ERP system, for example audit trails based on Lawson™ data, and all the repots generated by system 10 can be made specific to the operator OP of vendor management system 10, for example based on reports of the Lawson™ reporting modules. This is beneficial because all the internal reports of operator OP will already be based on the existing ERP system software, and vendor management system 10 is thereby fully integrated into existing ERP infrastructure and will take advantage of the advanced reporting, accounting and document back-up tools of the ERP system. In this way, specific reports can be generated that are based on OP's internal information technology and operation standards, such as but not limited to expiration reports, executive summary reports 750, vendor payment histories, vendor payment status. Also, reporting module 600 can generate system reports such as but not limited to data input and analysis reports from analyst AN, supervisor SU, administrator AD, executive summary reports 750 by the automatic credentialing, relationship reports, and proximity reports.

Risk module 700 provides functions to assess different types of risk that are associated with the individual registered vendors RV₁-RV₄. Risk module 700 allows the system to generate risk scores, detailed risk profiles, and risk relationship profiles for a selected vendor based on algorithms that take various factors into account. Risk module 700 relies on data that has been accessed using other modules, such as web services module 900 and vendor performance module 1200.

Moreover, vendor dashboard 800 module is configured to display a graphical user interface with functions and data for registered vendors RV₁-RV₄, for example a display of the most pertinent data to a the registered and logged-on vendor, and to provide tools allowing vendors to access and change data of the respective account at the vendor management system 10. For example, vendor dashboard module 800 allows a vendor to maintain his account, for example to update his account with new information, edit the vendor profile, and can provide a brief overview of his account via a graphical user interface. Web services module 900 is an object that provides for various functions to access different web-based services over the Internet. This can include, but is not limited to Data Universal Numbering System (DUNS) web services for corporations provided by the Dun and Bradstreet™ online service, Federal Employer Identification Number (FEIN) lookup, Excluded Parties List Services (EPLS) or Office of Inspector General (OIG) look-up, ERP web service look-up such as Lawson™, United States Postal Service (USPS) look-up for address verification, access to payment service provider such as PayPal™ or a Credit Card processing gateway, access to web services of legal and financial data providers.

Moreover, bid management module 1100 is an object that can provide for various functions for the users to manage bids with respect to vendors, for example module 1100 can provide a bid history form for particular vendors selected by the user, a tool to create bid information and edit existing bid information, function to provide online request-for-proposal (RFP) submissions, track RFP's initiation and response by an identified, compare and correlate different bids for flagging. In addition, a vendor performance module 1200 is provided which is an object that can provide functions for track, display, archive and predict vendor performance. For example, module 1200 can provide a graphical display of vendor performance feedback data records, vendor performance feedback report, vendor performance report.

The term ‘object’ as used above is understood to be a functional entity of a computer system performing different processes and methods that allow to perform various functions for users and vendors, based on computer-readable instructions that are executed by one or more hardware processors of the vendor management system 10. These functions can be used by various methods that may be performed by vendor management system 10, for example when by operated by users U, vendors PR or RV. The one or more hardware processors of system 10 may be located at a central or distributed server that are connected via a network, but can also be located at a computer of the vendor or the user that are connected to a network, for example the Internet. Moreover, it is possible that parts or entire functions of the ‘software objects’ are actually implemented as hardware on programmable logic devices (PLD) or field programmable gate arrays (FPGA), especially those who require a high amount of processing power. The term ‘object’ does not necessary refer to object-oriented architecture of the software design, but can also include class-based programming, agent-based programming, or prototype-based programming.

FIG. 4 shows a schematic exemplary overview of the hardware elements of the vendor management system 10. Webserver 35 is shown that provides an exemplary hardware structure for implementing web services layer 4, and allows to provide for web interface pages, web-based access interfaces, e-mail services, such as accesses performed by web services module 900 or the communication performed by the e-mail notification module 300. Server 40 operates as a central processing server that runs most of the modules of the system 10, for example by not limited to account module 100, administration module 200, user and vendor dashboards 400, 800, risk module 700, bid management module 1100, and provides for an exemplary hardware structure to implement work flow layer 3 but also the web interface layer 2. Database server 42 is configured for database management, for example a Microsoft™ SQL server or Oracle™, XML database management servers, I2 iBase™ database application, and provides for an exemplary structure to implement data layer 5. Database server 42 supports main processing server 40 for accessing vendor database 50, user database 51, and general system database 52 for reading or storing data therein, for example storing reports generated by reporting module 600 associated to a registered and selected vendor to vendor database 50, or for accessing data on registered vendors from vendor database 50, for example by administration module 200, vendor dashboard module 800, or when user dashboard accesses and stores data to user database 51. General system database 52 can store data that is generic to all users of vendors, for example industry classification data, weight factors for algorithms, algorithms, reports summarizing general industry trends based on all vendor and user data. To increase safety of the servers 35, 40, 42 and databases 50, 51, 52 are behind a firewall 45 for any Internet access. Databases 50, 51, 52 can be used for storing information that is generated or received by system 10 and can be proprietary to the vendor management system 10, for example but not limited to cumulated data on vendors, calculated risk scores, risk profiles, executive summary reports, historical data on vendors, vendor registration information. It is also possible that databases 50, 51, 52 are cloud-based, web-accessible data storage servers, such as Dropbox™, and are therefore not in direct connection and local to main processing server 40. Disk drive 37 or another type of data input/output device such as Universal Serial Bus (USD) reader, BluRay™ reader/writer, hot-swappable hard drives, memory card reader, digital video disk (DVD) player can also be connected to at least one of servers 35, 40, 42, usually main processing server 40. A computer-readable data storage device 39, for example a CD-ROM, DVD, BluRay™ disk, thumb drive, portable hard drive, memory card, can be read by drive 37 for example but not limited to for loading executable computer instructions that are stored on the device 39, safeguard and archive vendor and user data, save reports.

System 10 can also access external servers 61, 62, 63, 64 and associated databases 71, 72, 73, and 74 that allow for certain web-accessible services over Internet 30. To access servers 61, 62, 63, 64, main processing server 40 can have the requisite application programming interfaces (API) that can be called upon by the modules 100-1200. FIG. 3 represents different servers providing Internet access for different types of information related to the vendors. For example, portal web server 61 can be a server that allows web access to at least one of legal and financial web service providers such as Thomson Reuters™ data service server, LexisNexis™, Securities Exchange Commission (SEC) server, Bloomberg™, to access their web interface and file transfer protocol (FTP) with a secured access to information on the legal history information, such as bankruptcy filings, civil suits, agency investigations, ownership information, financial information from reports at the SEC, published financial data, financial reports, criminal background of a vendor and their key people. Server 62 is a consent-based Social Security number verification service (CBSV) and database 72 a SSN/FEIN database that allows system to securely access this service to verify SSN and FEIN numbers. Server 62 may be accessible over web portal pages such as “www.ssa.gov” or “www.feinsearch.com.” Server 63 is a DUNS look-up gateway server that allows system 10 to access the Dun and Bradstreet™ online service to access business information reports, comprehensive reports, and credit ratings of D&B registered vendors, such as but not limited to Paydex scores, commercial credit scores, financial stress scores. Server 62 can be accessed via a dedicated application programming interface (API) to access verification data from database 72 to acquire D&B reports and to verify D&B identification numbers.

Webserver 64 can be the EPLS web server allowing system to access and compare a list of vendors that are excluded by Federal government agencies from receiving Federal contacts or federally approved subcontracts and from certain type of Federal financial and nonfinancial assistance and benefits. In a variant, the server of the OIG is used. The EPLS and OIG can be used for system 10 to acquire information on administrative and statutory exclusions that have been made within the Federal government related to project participation and funding. An API is accessible at the main processing server 40 allowing access the EPLS webserver 64 by using the web service definition language (WSDL). Other webservers that system 10 can access includes, but is not limited to North American Industry Classification System (NAICS) webserver for validate NAICS codes United States Postal Service (USPS) webserver for requesting address verification by using the USPS shipping web tools server, ERP software access for operator OP, such as Lawson™ webserver, for accessing data of the operator OP. Also, a payment webserver can be accesses, for charging users for the services rendered by system 10, for example a PayPal™ server or a Credit Card payment gateway.

Moreover, system 10 is connected to the Internet 30 for communicating with various terminals 15, 17, 19, 20, 22 that may be used by users U₁-U₂, vendors PV and RV₁-RV₄, administrators AD, analyzers AN, and supervisors SU of system 10, and represent exemplary hardware implementations of device that provides access for U₁-U₂, PV, RV₁-RV₄, AD, AN, and SU to the functionalities and information provision of system 10, controlled by access rights. In the exemplary embodiment shown in FIG. 3, a user can access system 10 via terminal 20 that is connected to the Internet 30, terminal 20 having a screen for displaying various graphical user interfaces of the system 10 for the user, for example but not limited to interfaces for data entry, tables, graphs, spreadsheets, webpages, documents. Also, a printer 22 may be connected to terminal 20 directly or indirectly via an intranet 32 or Internet 30. Also, users may be operating system 10 with a mobile device 24 or a tablet computer 26 that is wirelessly connected to the Internet 30 with a cellular data network base station 80, such as Edge, 3G, 4G, or other wireless data network. Vendors may use terminal 15 having a display screen 16 that is also connected to Internet 30 for accessing system 10, or can be using a mobile device 17 or a tablet computer 19 to access system 10, via mobile Internet, analogously to the user's terminals 20, 24, 26.

The hardware architecture shown in FIG. 3 is only exemplary, and many other possibilities exist to implement vendor management system 10 as can be readily understood by one of ordinary skill in the art. For example, servers 35, 40, 42 can be implemented as distributed servers in a cloud computing environment that require web interfaces to access each other over the Internet, but servers 35, 40, 42 can also be simply implemented on a single hardware server. Also, databases 50, 51, 52 can be remote and cloud-based storage spaces that are accessible over a network such as the Internet 30, or can simply be on internal hard drives of servers 35, 40, 42 or other internal data storage mediums.

FIG. 5A schematically depicts a flowchart of processes performed at system 10 when accessed by non-registered potential vendors PV, registered vendors RV₁-RV₄, and users U₁-U₂, from account creation to risk score and report generation for users. The method consists in an account creation step S10, vendor registration step S20, review step S30 with the sub-steps web data access step S32, analyst AN review step S34, and user requesting vendor step S36, approval step S40, vendor search step S50, and an automatic vendor credentialing step S60. As indicated in FIG. 5A, steps S10-S40 deal with the creation of registered and approved vendors RV₁-RV₄, and steps S50-S60 deal with steps for the user to search and automatic credential registered and approved vendors RV₁-RV₄.

In the account creation step S10, a potential vendor can access system 10 via a webpage, dedicated application, or special terminal to create an account with the intention to later fully register at system 10 as a registered vendor RV₁-RV₄ that can be searched by users U₁-U₂ for their offers, sales, and contracting. It is possible that administrator AD reviews the vendor account creation data for formal compliance before PV is actually permitted to confirm creation of his new account. Next, in the registration step S20, potential vendors PV need to login into system 10 by their account created in step S10, for example by logging in using first name, last name, e-mail address, and security questions and answers. The log-in information can be specific to an agent or employee of vendor PV that is authorized for this access. PV will be required to enter a substantial amount of data related to their business, usually via various web forms. Some of this data will be automatically verified by accessing web-accessible databases by web-services module 900. Step S20 is usually performed, after PV accesses system 10 for the first time since account creation step S10, In this step, generated by vendor dashboard 800, PV will be shown a vendor registration menu for completing the vendor registration profile. Vendor dashboard module 800 can also generate an interface that will allow vendor OV to, edit the vendor profile information, but module 800 can also evoke automatic processes to verify the information provided, or to autofill entries by access to web databases via web services module 900. Once the vendor profile information is complete, registration step S20 is terminated, and the vendor account can be reviewed for release, in step S30

Review step S30 is usually performed without the interaction of vendor PV, and is usually performed internal to operator OP of vendor management system 10. Upon receiving the non-registered vendor account from step S20, a supervisor SU can decide whether he wants to release vendor PV for search and automatic credentialing. Thereby, a certain pre-selection of vendors PV can be done, without the requirement that vendor PV goes through full registration. This decision based on various factors, such as but not limited to whether vendor PV actually fits into the services or products categories they want to offer to users U₁-U₂ based on their industry classification, whether there are already some red flags that are apparent from the vendor account creation information that are against the operator's policy for full release of vendor PV, whether a certain maximal number of vendors RV₁-RV₄ has been reached based on operator's policy, whether vendor PV is outside the geographic area of operation, whether the vendor has already been registered. Also, it is possible that users U₁-U₂ trigger the review step S30, by making a specific request for a vendor PV, by user request step S36. User request step S36 can also be performed before the vendor PV has actually set-up an account, and can therefore trigger that a PV creates the account in the first place, with step S10.

Next, supervisor SU or system 10 can send the vendor profile information to step S32 of performing an electronic data gathering step, in which various data entries of the vendor profile information are checked with the web services module 900. For example, legal database 980 and DUNS database 910 can be accessed to verify and gather additional information from vendor PV. Next, the vendor profile information, and the additional date gathered related to vendor PV, for example legal history information and scores such as commercial credit score, financial stress score, and Paydex™ score can be presented to an analyst AN so that he can review the information, and make a recommendation decision back to supervisor SU whether PV should be released for automatic credentialing, in analyst review step S34. In this step, an analyst AN that is usually an employee of operator OP reviews the vendor profile information, and can send an analyst report to supervisor SU. The analyst report can be an electronic report that can include a full recommendation of a vendor PV, a recommendation with certain reservations, or a recommendation of denial, for example based on a presence of vendor of the EPLS or OIG exclusion list, or criminal activity of vendor PV and one of the owners OW or officers O, and this report can be generated by reporting module 600. Analyst can leave comments to further comment on his observations and analysis. Next, supervisor SU receives the analyst report, and makes the final decision whether to release vendor PV for automatic credentialing for users U_{I}-U₂. If supervisor releases vendor PV, his status is changed to a registered vendor RV, and vendor is notified of this event by e-mail via e-mail notification module. The associated vendor profile information in vendor database 50 will be labeled as such.

Vendor search step S50 allows registered and logged-in users U₁-U₂ to search for various registered vendors, and this step is managed by user dashboard 400 that provides for tools via a graphical user interface to browse for vendors RV₁-RV₄ based on different criteria, or to perform searches based on different criteria. Vendors RV₁-RV₄ that are found in vendor search step S50 can be presented to users U₁-U₂ in the form of a list for selection. Next, users U₁-U₂ or the system 10 itself, can trigger an automatic credentialing of vendors RV₁-RV₄ by automatic credentialing step S60. This step S60 can generate various reports on the risks associated to vendors, using reporting module 600 including but not limited a risk score, executive summary report, relationship diagrams, proximity diagrams, interlocking relationship alerts, proximity alerts, score alerts. Vendors RV₁-RV₄ themselves do not receive a copy of the reports of the automatic credentialing, because this reports may include information that may be part of the analysts AN or the supervisor SU opinion, and is not public information due to privacy concerns. However, it is possible that vendors RV₁-RV₄ receive a notification that such automatic credentialing has been performed, and indicating the identity of the user U₁-U₂ that requested automatic credentialing. Reports generated by automatic credentialing step S60 are available to the registered user U and the e-mail address or mailing address indicated therein, but a copy is usually also provided to the accounting or accounts receivable department of user U for review.

FIG. 5B depicts a more detailed flow-chart for the processes performed in the account creation step S10. The method includes an account creation step S10.1, account confirmation request step S10.2, account confirmation step S10.3, an account reconfirmation step S10.4, and a more detailed flow-chart for the processes performed in the vendor registration step S20, including the login step S20.1, profile and data gathering step S20.2, and data completion step S20.3. These steps can be performed by main processing server 40 as a central processing unit, but it is also possible that by distributed data processing using JavaScript™ and over web-based plugin software, that parts of these method steps are performed at vendor terminals 15, 17, 19 themselves.

Account creation request step S10.1 consists of several sub-processes that are handled by registration module 500 for allowing a potential vendor PV to create an account with system 10. Step S10.1 is evoked from an account creation webpage as a web form that allows a potential vendor PV to click on a new vendor registration link. First, registration module 500 will display the account creation webpage with the terms of use for system 10. A link allows to send a document of the terms of use to printer 22 for printing or allows to access the file system of terminal 20 for storage, for example as a portable document format (PDF) or Word document. Once the terms of use are accepted by PV, an electronic form will be generated by registration module 500 and displayed on display screen 21 for completion by PV. Electronic form will have required fields and optional fields for registration. FIG. 5C shows a screenshot of an exemplary graphical user interface for step S10.1 for the account creation request form that will be stored in vendor database 51 under vendor profile information. Required fields can be highlighted by a special shading or color tone to bring them to the attention of the user. Table II below shows a table representing the required fields that are presented to PV by a web form of a graphical user interface for creating an account with system 10, with exception of the SSN that can be optional. The first row of Table II includes the description for the respective columns, including entry number, display category, field name, type of data entry, additional comments, validation of data entry, and whether an entry to the field is required or optional.

TABLE II

| En- | Display | | | | | Re- |
|---|---|---|---|---|---|---|
| try | cate- | Field | | | | quired |
| No | gory | Name | Type | Comments | Validation | Field |
| 1 | Terms | I Agree | Check | | | Yes |
| | of Use | with | Box | | | |
| | | above | | | | |
| | | Terms | | | | |
| | | of Use | | | | |
| 2 | Terms | Legal | Text Box | | | Yes |
| | of Use | Company | | | | |
| | | Name | | | | |
| 3 | Terms | Legal | Radio | | Choices will be: | Yes |
| | of Use | Structure | Button | | Corporation | |
| | | | Selection | | Sole Proprietor | |
| | | | | | S-Corporation | |
| | | | | | Limited Liability | |
| | | | | | Corporation | |
| | | | | | Partnership | |
| 4 | Terms | FEIN | Text Box | | Numeric. | Yes |
| | of Use | | | | Web Service 920 | |
| | | | | | will validate | |
| | | | | | FEIN. | |
| 5 | Terms | SSN | Text Box | Sole | SSN active if | No |
| | of Use | | | Proprietors | sole proprietor | |
| | | | | will input | is selected. | |
| | | | | SSN | | |
| 6 | Terms | Contact | Text Box | | | Yes |
| | of Use | First | | | | |
| | | Name | | | | |
| 7 | Terms | Contact | Text Box | | | Yes |
| | of Use | Last | | | | |
| | | Name | | | | |
| 8 | Terms | Contact | Text Box | | Email Address | Yes |
| | of Use | Email | | | Format | |
| | | | | | xxxxx@xxxx.xxx | |
| 9 | Terms | Account | Text Box | | | Yes |
| | of Use | Username | | | | |
| 10 | Terms | Account | Text Box | | | Yes |
| | of Use | Password | | | | |
| 11 | Terms | Account | Text Box | | | Yes |
| | of Use | Password | | | | |
| | | (Retype) | | | | |
| 12 | Terms | Security | Drop- | Users | | Yes |
| | of Use | Question | down | will be | | |
| | | | Selection | provided | | |
| | | | Box | with a list | | |
| | | | | of possible | | |
| | | | | questions | | |
| 13 | Terms | Answer | Text Box | | | Yes |
| | of Use | | | | | |
| 14 | Terms | Security | Text Box | Instruc- | Entered text will | Yes |
| | of Use | Check | | tions will | be validated | |
| | | | | be provid- | against the text | |
| | | | | ed next to | shown in | |
| | | | | the text | Captcha ™ | |
| | | | | box to type | image. | |
| | | | | words | | |
| | | | | shown | | |
| | | | | above. | | |

Column 5 of Table II shows validation procedures that can be automatically called up upon completion of the corresponding field, or can be called up upon clicking button, icon or link indication the creation of an account. For this purpose, web services module 900 can be evoked to check various entries to the data field of the account creation webpage, for example to have the FEIN and SSN verified by web server 62 to see if it exists or if there is already an entry for the corresponding vendor in system 10, verification of an address by the USPS shipping web tools server. Also, other verification procedures can be called up locally within the registration module 500, for example for verifying proper e-mail and telephone formats, verify whether a password corresponds to a password policy of the system, verification of a security check by Captcha™ images challenge-response questions to ascertain that the web form is being filled out by a human being. For certain fields, a drop box can present items that can be selected by the PV, for example the legal structure of the vendor, being sole proprietorship, corporation, S-corporation, limited liability corporation, partnership. Also, a list of possible security questions can be presented to a PV that can be selected from a drop box. Once all the required fields of the web form are completed, the created account button can be highlighted and clicked by the user for account creation. This data is stored in a vendor registration data entry field into a vendor data database 51.

Next, an account confirmation request step S10.2 can be performed, in which an email is sent to the e-mail address indicated for the particular vendor of the corresponding account creation request data, evoking e-mail notification module 300. The e-mail can include a confirmation weblink that PV can be clicked or selected to confirm the account registration request of the vendor at the vendor management system 10. After clicking or selecting the link, a webpage can be opened that is generated by vendor management system 10 stating that the e-mail associated to the temporary account has been confirmed, and that the PV can now proceed to full registration, and release for automatic credentialing. The confirmation web link can include a one-time generated code that hashes secret information identifying PV, a time stamp, and information identifying vendor management system 10, so that system 10 can ascertain the link has been actually clicked on in time by an authorized party. The PV now has the possibility via the displayed web page to confirm the account creation request for his account.

Once confirmation link has been clicked on, system 10 performs an account confirmation step S10.3 in which the vendor registration data of the PV may or may not be released to an administrator AD for internal confirmation. Administrator AD can automatically or manually reviews the vendor registration request data, for example by checking data for consistency. For this purpose, a user interface having access rights for administrators AD can be used, and the administrator AD can confirm the account creation for vendor PV and his vendor account creation request data by a clicking an icon. Next, the account reconfirmation step S10.4 is performed, in which an e-mail is sent to the PV that the account creating form has been completed and received, and that the account is now active. The process shown in FIG. 5B is similar for users U₁-U₂ to create accounts for being able to access system 10 and search for vendors RV₁-RV₄.

For analyzing data of potential vendors and requesting data by the web access step S32, and for automated credentialing of vendors RV₁-RV₄ with step S60 for accessing the newest data for risk calculation, and for registering users U₁-U₂, and other processes that need current data, it is possible to evoke web services module 900 that is described in further detail below. Web services module 900 provides for various processes to acquire external data from various Internet-accessible sources, shown in FIG. 6. A DUNS look-up process 910 can be evoked to look-up registered DUNS numbers. Dun and Bradstreet™ (D&B) services provides for a subscription-based API data toolkit 910 that can be integrated into DUNS look-up process 910 of webservices module 900. This allows to check validity of DUNS numbers, and can also be used to acquire Paydex scores, commercial credit scores, and financial stress scores. FEIN look-up process 920 allows system 10 to look-up FEIN numbers via webpages, for example “www.feinsearch.com” to validate vendor-provided FEIN numbers, as explained above. Alternate verification websites can also be accessed as a back-up. The web service accessed by the FEIN look-up process 920 can accept and verify a 9-digit FEIN number, and will return to FEIN look-up process 920 a business name, address, state, ZIP, and contact name. The FEIN look-up process 920 will not yield results for small businesses using personal social security number (SSN) as the business tax identification number, for example S-corporations, and any SSN numbers entered may or may not be verified with a verification services, depending on privacy concerns. Next, a NAICS validation process 930 can be evoked from web services module 900, in which NAICS codes can be validated that were entered by a vendor. Also, vendor management system 10 can locally store NAICS code tables in one of the locally general system database 52. The following Table III shows the level 1 listing of the NAICS classification codes, and each level has many sublevel categories, along with a numerical code assigned to it.

TABLE III

| Level 1 | Level Description |
|---|---|
| 11 | Agriculture, Forestry, Fishing, |
| | and Hunting |
| 21 | Mining, Quarrying, Oil and |
| | Gas Extraction |
| 22 | Utilities |
| 23 | Construction |
| 31-33 | Manufacturing |
| 42 | Wholesale Trade |
| 44-45 | Retail Trade |
| 48-49 | Transportation and |
| | Warehousing |
| 51 | Information |
| 52 | Finance and Insurance |
| 53 | Real Estate, Rental, Leasing |
| 54 | Professional, Scientific, and |
| | Technical Services |
| 55 | Management of Companies and |
| | Enterprises |
| 56 | Administrative, Support, Waste |
| | Management, and Remedial |
| | Services |
| 61 | Educational Services |
| 62 | Health Care, Social Assistance |
| 71 | Arts, Entertainment, Recreation |
| 72 | Accommodation, Food Services |
| 81 | Other Services (except public |
| | administration) |
| 92 | Public Administration |

For the vendor management system 10, NAICS codes can serve to classify different types of industries into different risk categories. Next, web services module 900 also operates a EPLS process 940 that allows system 10 to provide access to the single comprehensive list of individuals and firms that are excluded by Federal government agencies from receiving any federal contracts or federally approved subcontracts and from certain types of federal financing and non-financial assistance. For accessing the EPLS web server, special web services operations can be performed to access different types of information. For example, for a vendor, a list of different exclusion types, their dates of applicability, different types of actions, agency identifiers that identity the agencies involved for the particular vendor, can be returned to EPLS process 940 of system 10.

Moreover, web services module 900 also includes an address verification process 950 that allows to access the USPS web database or an equivalent web-based address verification system for verifying completeness and correctness of addresses, and can return ZIP codes and ZIP codes +4. The address verification process 950 can call the USPS web services by first making a connection to the USPS shipping web tool server, sending the address validate request, receiving the response from the web tool server, and then closes the Internet connection. Also, web services module 900 includes an ERP web service look-up process 960 that allows to access an ERP system that is used by operator OP of system 10, for example the Lawson™, PeopleSoft™, SAP™ and other ERP systems and databases. For example, ERP web service look-up process 960 allows to access the web service to look-up all employee information of the operator OP that can be used to discover relationships of the employees E, officers O, owners OW, or board B with registered vendors RV₁-RV₄. For example, operator OP, in addition to operate system 10, may have other employees that act as vendors themselves as operating vendor, or may there may be employees O that have a ownership interest in one of the vendors RV₁-RV₄. By accessing full employee records of operator OP, such relationships to vendors RV₁-RV₄ can be discovered and presented to users U₁-U₂ in the relationship diagrams or reports. In this way, operator OP can offer full transparency to users U₁ to U₂ regarding its own employees, and can have relationships between its employees and vendors RV₁-RV₄ discovered, and shown in a relationship diagram.

Upon requesting data from the ERP system of operator OP over the web interface, the ERP web service look-up process 960 can receive up-to-date detailed employee records, including address information. In the health care industry example, ERP web service look-up process 960 can access physician information and internal employee information from OP, and can make a local copy of this information into general information database 52. This access can be performed periodically, or upon performing a web data access step S32, or an automatic credentialing with step S60. In case operator OP acts as vendor himself, this data on the employees can be used to gather further information for the risk calculation by the automatic credentialing of a particular vendor, for example to access criminal, disciplinary, registration, suspension issues of an employee of operator OP.

Moreover, a web payment process 970 is also included in the web services module 900 that allows to process a payment from a user for using the system 10, or from a vendor that registers and maintains registration to system 10. Registered vendors RV₁-RV₄ as well as users U₁-U₂ can be charged on a regular basis for the services provided, for example a regular fee for vendors to be part of system 10, and a usage fee for users. It is possible that web payment process 970 stores account information of vendors, for example but not limited to PayPal™ account information, Visa™, Mastercard™, American Express™ credit card information, and is equipped with the requisite security to perform payment transaction with the respective webservers. Legal data access process 980 is also part of the web services module 900 and allows to query and access legal history information, registration information, and press information on a vendor, for example via Thompson Reuters™ webserver, LexisNexis™ or another web accessible data system, and financial data access process 990 is configured to query and access financial data information, in particular for publicly traded vendors, to access financial reports on profits, losses, turnover, for example from Thompson Reuters™ webserver, Bloomberg™ web-based data service, SEC financial data. This financial data access process also allows to access news reports of important financial events related to publicly traded, but also private vendors.

Registration module 500 includes a vendor registration process 510 for gathering full profile information on a vendor, and a user registration process 520 that allows to collect various information from a vendor, and is configured to display various graphical user interfaces for this purpose, for completing vendor profile, as shown in FIG. 7. Data gathered from a vendor is usually stored to vendor data database 50 under vendor profile information for a specific vendor, and data gathered from a user is usually stored to user data database 51. For example, these processes and sub-processes thereof are evoked when a registered vendor PV performs step S20 of FIG. 5A for entering data for his vendor profile information for approval and release, and performing some automatic data verification processes by evoking web services module 900 to verify data. Different processes can be performed that allow to display particular graphical user interfaces or elements of graphical user interfaces for entering data, including a company information process 520, including the sub-processes company overview 521, relationships 522, accounts payable 523, products and services offerings 524, a people information process 530 including sub-processes principal officers 531, principal owners 532, registered agents 533, board of directors 534, primary points of contact 535, an address information gathering process 540 including the sub-processes headquarters 541 and remit 542, a diversity information process 550 including the sub-processes minority ownership information 551, veteran status 552, small business ownership 553. Next, a reference process 560 is also part and can be evoked by registration module 500. Preferably, automatic credentialing step S40 will perform at least some of these processes.

Next, Tables IV-VIII present information that is gathered from vendor PV so that he can be fully registered and released, and will be saved as part of the vendor profile information in vendor database 50. The information gathering is performed by step S20.2 after vendor PV has logged into his account with step S20.1, and is managed by vendor dashboard 800. Tables IV-VIII show various information related to vendor PV indicating the order of display of the item in the graphical user interface, questions prompted to the vendor for information input, type of data, comments regarding the item and its display in the graphical user interface, validation procedures, and whether the field is required to be completed by vendor. This data is preferably stored to vendor registration database. Table IV represents the information that can be gathered by company information process 520, with entries 23-31 gathering information on relationships of employees, officers, vendors, with relationships sub-process 522. In particular, with entry 23 relationships can be discovered and registered between the registering vendor PV and the operator OP of the vendor management system 10. This feature is particularly advantageous in the healthcare industry, where operator OP of system 10 is himself a vendor of healthcare services that may be offered to hospitals, acting as an operating vendor, and therefore OP may also be registered in his own system 10 as a vendor RV₁ to RV₄. Accordingly, such entries can discover conflicts of interest that may arise between operator OP acting as a vendor RV, and other registered vendors RV₁ to RV₄ that have no relationship with operator OP of system 10, and system itself. Moreover, entry 25 allows to detect relationships of key employees, officers, etc. between a vendor PV and already registered vendors RV₁ to RV₄. This allows to create database entries in vendor data database 50 that document cross-relationships between all the vendors RV₁ to RV₄ to detect whether the vendors are fully independent from each other or not, as part of the vendor profile information. Entries 27-31 gathers information on the person who referred PV to system 10, and it can be checked whether the person who made the referral actually works at OP himself so that an conflict of interest can be detected by using the ERP data access module 960, or whether he is an employee of a registered vendor RV₁ to RV₄ that could somehow benefit from his referral.

TABLE IV

| Entry | Display | | | | | Required |
|---|---|---|---|---|---|---|
| No | category | Field Name | Type | Comments | Validation | Field |
| 1 | Company | Legal | Text Box | Text Box will be | | Yes |
| | Overview | Company | | pre-populated | | |
| | | Name | | with the name | | |
| | | | | but this field can | | |
| | | | | be updated | | |
| 2 | Company | DBA | Text Box | | | No |
| | Overview | | | | | |
| 3 | Company | Does the | Radio | | Boolean | Yes |
| | Overview | Company | Button | | (Yes/No) | |
| | | have a DUNS | | | | |
| | | number? | | | | |
| 4 | Company | DUNS | Text Box | | | No |
| | Overview | Number | | | | |
| 5 | Company | Federal Tax | Read Only | Completed at | | Yes |
| | Overview | ID (FEIN) | | account creation | | |
| 6 | Company | SSN | Read Only | Completed at | Required if | No |
| | Overview | | | account creation | FEIN is not | |
| | | | | | provided. | |
| 7 | Company | Has your | Radio | | Boolean | Yes |
| | Overview | Company | Button | | (Yes/No) | |
| | | Filed for | | | | |
| | | Bankruptcy? | | | | |
| 8 | Company | Year | Text Box | | Numeric (4 | Yes |
| | Overview | Established | | | digits) | |
| 9 | Company | Are you a US | Radio | | Boolean | Yes |
| | Overview | Company or | button | | (Yes/No) | |
| | | International | | | | |
| | | Company? | | | | |
| 10 | Company | Upload | File Upload | | | Yes |
| | Overview | W9/W8 | Box | | | |
| 11 | Company | Business | Check Box | | Multiple | Yes |
| | Overview | Classification | | | Choice | |
| | | | | | Choices | |
| | | | | | will be the | |
| | | | | | following: | |
| | | | | | Distributor, | |
| | | | | | Retailer, | |
| | | | | | Manufac- | |
| | | | | | turer, Service | |
| | | | | | Provider | |
| 12 | Company | Does your | Radio | | Choices | Yes |
| | Overview | company | Button | | will be: | |
| | | comply with | | | Yes | |
| | | HIPAA | | | No | |
| | | regulations | | | Don't | |
| | | (Link to | | | Know | |
| | | HIPAA | | | | |
| | | Regulations) | | | | |
| 13 | Company | Stock | Text Box | | | No |
| | Overview | Symbol | | | | |
| 14 | Company | Public or | Radio | | Boolean | Yes |
| | Overview | Private | Button | | (Yes/No) | |
| | | Company? | | | | |
| 15 | Company | SEC | Text Box | | Field | No |
| | Overview | Registration | | | available | |
| | | # | | | only if the | |
| | | | | | vendor is a | |
| | | | | | public | |
| | | | | | company. | |
| 16 | Company | Total | Drop-down | | Choices | Yes |
| | Overview | Number of | Selection | | will be: 1, | |
| | | Employees | Box | | 2-9, 10-49, | |
| | | | | | 50-99, 100- | |
| | | | | | 499, 500- | |
| | | | | | 999, 1000- | |
| | | | | | 5000 and | |
| | | | | | 5000+ | |
| 17 | Company | Annual Sales | Text Box | | | No |
| | Overview | | | | | |
| 18 | Company | Bonding | Text Box | | | No |
| | Overview | Company | | | | |
| 19 | Company | Bonding | Text Box | | | No |
| | Overview | Amount | | | | |
| 20 | Company | Ownership of | Radio | | Boolean | Yes |
| | Ownership | Other | Button | | (Yes/No) | |
| | | Business | | | | |
| | | Entities? | | | | |
| 21 | Company | Name of | Text Box | | Field active | Yes |
| | Ownership | Other | | | only if the | |
| | | Business | | | answer to | |
| | | Entities | | | question | |
| | | | | | “Ownership | |
| | | | | | of Other | |
| | | | | | Business | |
| | | | | | Entities?” | |
| | | | | | is “Yes”. | |
| 22 | Company | Other | Number | Add Other | Field active | Yes |
| | Ownership | Business | | Business button | only if the | |
| | | Entity FEIN | | will be provided | answer to | |
| | | | | to allow for more | question | |
| | | | | than one business | “Ownership | |
| | | | | to be added. | of Other | |
| | | | | | Business | |
| | | | | | Entities?” | |
| | | | | | is “Yes”. | |
| 23 | Relationships | Are you or | Radio | | Choices | Yes |
| | | any officers | Button | | will be: | |
| | | related to any | | | Yes | |
| | | employee(s) | | | No | |
| | | of the | | | Don't | |
| | | operators OP | | | Know | |
| | | of the system | | | | |
| | | 10, i.e. | | | | |
| | | physician, | | | | |
| | | employee, | | | | |
| | | spouse, | | | | |
| | | children? | | | | |
| 24 | Relationships | If so, please | Text Box | | | Yes |
| | | list name and | | | | |
| | | relationship | | | | |
| 25 | Relationships | Are you or | Radio | | Choices | Yes |
| | | any officers | Button | | will be: | |
| | | related to any | | | Yes | |
| | | vendors RV₁ | | | No | |
| | | to RV₄ that | | | Don't | |
| | | are working | | | Know | |
| | | with system | | | | |
| | | 10? | | | | |
| 26 | Relationships | If so, please | Text Box | | | Yes |
| | | list name of | | | | |
| | | the company | | | | |
| | | and | | | | |
| | | relationship | | | | |
| 27 | Relationships | Were you | Radio | | Boolean | No |
| | | referred to | Button | | (Yes/No) | |
| | | system 10? | | | | |
| 28 | Relationships | Refer First | Text Box | | | No |
| | | Name | | | | |
| 29 | Relationships | Refer Last | Text Box | | | No |
| | | name | | | | |
| 30 | Relationships | Department | Text Box | | | No |
| 31 | Relationships | Hospital | Text Box | | | No |
| 32 | Accounts | Does your | Radio | | Boolean | No |
| | Payable/ | company | Button | | (Yes/No) | |
| | Accounting | have | | | | |
| | department | Electronic | | | | |
| | | Data | | | | |
| | | Interchange | | | | |
| | | (EDI)? | | | | |
| 34 | Accounts | Can you | Radio | | Boolean | No |
| | Payable/ | process | Button | | (Yes/No) | |
| | Accounting | invoices | | | | |
| | department | electronically? | | | | |
| 35 | Products and | Regions in | Drop-down | | Choices | Yes |
| | Services | which you | Selection | | will be: | |
| | offering | can provide | Box | | Local, | |
| | | products and | | | Regional, | |
| | | services | | | National, | |
| | | | | | International | |
| 36 | Products and | NAICS Code | Drop-down | Selecting the | | Yes |
| | Services | | Selection | two-digit code | | |
| | offering | | Box | will populate a | | |
| | | | | selection box | | |
| | | | | below. Vendors | | |
| | | | | will have the | | |
| | | | | ability to further | | |
| | | | | narrow down the | | |
| | | | | choices by | | |
| | | | | selecting from | | |
| | | | | the options | | |
| | | | | presented in the | | |
| | | | | left table and | | |
| | | | | populating the | | |
| | | | | right table. If a | | |
| | | | | Vendor provides | | |
| | | | | two or more | | |
| | | | | different types of | | |
| | | | | products/services, | | |
| | | | | selecting a | | |
| | | | | different code | | |
| | | | | from the NAICS | | |
| | | | | Code(s) drop- | | |
| | | | | down menu will | | |
| | | | | then auto | | |
| | | | | populate the left | | |
| | | | | table. | | |

Next, Table V presents information that will be gathered from RV on personnel, in the personnel or people information process 530 including the above-mentioned sub-processes principal officers 531, principal owners 532, registered agents 533, board of directors 534, primary points of contact 535. Collectively, different personnel that are registered by this process can be referred to as key people related to the vendor RV. Usually, multiple records can be added to each type of personnel listed in the entries of Table V. Also, people information will not be collected for multi-national corporations, and for national, publicly traded companies, because such companies are already subject to Security Exchange Commission (SEC) checks and audits, because a lot of data of publicly traded companies are available publicly due to SEC regulations and reporting. However, local, regional, and national corporations will have to enter the personnel information for registration with system 10, because most such vendors have little or no publicly available data and auditing available, so by having information on key people, more information on such vendor can be gathered. This data can be stored in a vendor registration data entry field into a vendor data database 50, and can be part of the vendor profile information. However, it is also possible that this information is stored in the vendor database 50 in a separate table or database file associated to the registering vendor RV, so that system can more efficiently crosscheck different people information in tables between the different registered vendors to find a match. Also, it is possible that the people information is stored in a separate database that is established only for people information, with a separate index file for easier search and matching. Preferably, such separate database and index is used if the registered vendors have a large number of employees E, officers O, and board B.

TABLE V

| Entry | Display | | | | | Required |
|---|---|---|---|---|---|---|
| No | category | Field Name | Type | Comments | Validation | Field |
| 1 | Principal | Last Name | Text Box | | | Yes |
| | Officer | | | | | |
| 2 | Principal | First Name | Text Box | | | Yes |
| | Officer | | | | | |
| 3 | Principal | Phone | Text Box | | | Yes |
| | Officer | Number | | | | |
| 4 | Principal | Email | Text Box | | Email | Yes |
| | Officer | Address | | | Address | |
| | | | | | Format | |
| | | | | | xxxx@xxxx.xxx | |
| 5 | Principal | Home | Text Box | Address will be | | Yes |
| | Officer | Address 1 | | validated against | | |
| | | | | the USPS format | | |
| | | | | with address | | |
| | | | | verification | | |
| | | | | process 950 | | |
| 6 | Principal | Home | Text Box | | | No |
| | Officer | Address 2 | | | | |
| 7 | Principal | City | Text Box | | | Yes |
| | Officer | | | | | |
| 8 | Principal | State | Drop-down | | Choices | Yes |
| | Officer | | Selection | | will be: | |
| | | | Box | | 50 states | |
| | | | | | list | |
| 9 | Principal | Zip | Text Box | | | Yes |
| | Officer | | | | | |
| 10 | Principal | Zip + 4 | Text Box | | | No |
| | Officer | | | | | |
| 11 | Principal | Country | Drop-down | | Choices | Yes |
| | Officer | | Selection | | will be: | |
| | | | Box | | Country list | |
| 12 | Principal | DOB | Text Box | Calendar | Date | Yes |
| | Officer | | | Control | Format | |
| | | | | | MM/DD/YYYY | |
| 13 | Principal | Last Name | Text Box | | | Yes |
| | Owner | | | | | |
| 14 | Principal | First Name | Text Box | | | Yes |
| | Owner | | | | | |
| 15 | Principal | Phone | Text Box | | | Yes |
| | Owner | Number | | | | |
| 16 | Principal | Email | Text Box | | Email | Yes |
| | Owner | Address | | | Address | |
| | | | | | Format | |
| | | | | | xxxx@xxxx.xxx | |
| 17 | Principal | Home | Text Box | Address will be | | Yes |
| | Owner | Address 1 | | validated against | | |
| | | | | the USPS format | | |
| | | | | with address | | |
| | | | | verification | | |
| | | | | process 950 | | |
| 18 | Principal | Home | Text Box | | | No |
| | Owner | Address 2 | | | | |
| 19 | Principal | City | Text Box | | | Yes |
| | Owner | | | | | |
| 20 | Principal | State | Drop-down | | Choices | Yes |
| | Owner | | Selection | | will be: | |
| | | | Box | | 50 states | |
| | | | | | list | |
| 21 | Principal | Zip | Text Box | | | Yes |
| | Owner | | | | | |
| 22 | Principal | Zip + 4 | Text Box | | | No |
| | Owner | | | | | |
| 23 | Principal | Country | Drop-down | | Choices | Yes |
| | Owner | | Selection | | will be: | |
| | | | Box | | Country list | |
| 24 | Principal | DOB | Text Box | Calendar | Date | Yes |
| | Owner | | | Control | Format | |
| | | | | | MM/DD/YYYY | |
| 25 | Registered | Last Name | Text Box | | | Yes |
| | Agent | | | | | |
| 26 | Registered | First Name | Text Box | | | Yes |
| | Agent | | | | | |
| 27 | Registered | Phone | Text Box | | | Yes |
| | Agent | Number | | | | |
| 28 | Registered | Email | Text Box | | Email | Yes |
| | Agent | Address | | | Address | |
| | | | | | Format | |
| | | | | | xxxx@xxxx.xxx | |
| 29 | Registered | Home | Text Box | Address will be | | Yes |
| | Agent | Address 1 | | validated against | | |
| | | | | the USPS format | | |
| | | | | address | | |
| | | | | verification | | |
| | | | | process 950 | | |
| 30 | Registered | Home | Text Box | | | No |
| | Agent | Address 2 | | | | |
| 31 | Registered | City | Text Box | | | Yes |
| | Agent | | | | | |
| 32 | Registered | State | Drop-down | | Choices | Yes |
| | Agent | | Selection | | will be: | |
| | | | Box | | 50 states | |
| | | | | | list | |
| 33 | Registered | Zip | Text Box | | | Yes |
| | Agent | | | | | |
| 34 | Registered | Zip + 4 | Text Box | | | No |
| | Agent | | | | | |
| 35 | Registered | Country | Drop-down | | Choices | Yes |
| | Agent | | Selection | | will be: | |
| | | | Box | | Country list | |
| 36 | Registered | DOB | Text Box | Calendar | Date | Yes |
| | Agent | | | Control | Format | |
| | | | | | MM/DD/YYYY | |
| 37 | Board of | Last Name | Text Box | | | Yes |
| | Directors | | | | | |
| 38 | Board of | First Name | Text Box | | | Yes |
| | Directors | | | | | |
| 39 | Board of | Phone | Text Box | | | Yes |
| | Directors | Number | | | | |
| 40 | Board of | Email | Text Box | | Email | Yes |
| | Directors | Address | | | Address | |
| | | | | | Format | |
| | | | | | xxxx@xxxx.xxx | |
| 41 | Board of | Home | Text Box | Address will be | | Yes |
| | Directors | Address 1 | | validated against | | |
| | | | | the USPS format | | |
| | | | | with address | | |
| | | | | verification | | |
| | | | | process 950 | | |
| 42 | Board of | Home | Text Box | | | No |
| | Directors | Address 2 | | | | |
| 43 | Board of | City | Text Box | | | Yes |
| | Directors | | | | | |
| 44 | Board of | State | Drop-down | | Choices | Yes |
| | Directors | | Selection | | will be: | |
| | | | Box | | 50 states | |
| | | | | | list | |
| 45 | Board of | Zip | Text Box | | | Yes |
| | Directors | | | | | |
| 46 | Board of | Zip + 4 | Text Box | | | No |
| | Directors | | | | | |
| 47 | Board of | Country | Drop-down | | Choices | Yes |
| | Directors | | Selection | | will be: | |
| | | | Box | | Country list | |
| 48 | Board of | DOB | Text Box | Calendar | Date | Yes |
| | Directors | | | Control | Format | |
| | | | | | MM/DD/YYYY | |
| 49 | Primary Point | Last Name | Text Box | | | Yes |
| | of Contact | | | | | |
| 50 | Primary Point | First Name | Text Box | | | Yes |
| | of Contact | | | | | |
| 51 | Primary Point | Phone | Text Box | | | Yes |
| | of Contact | Number | | | | |
| 52 | Primary Point | Email | Text Box | | Email | Yes |
| | of Contact | Address | | | Address | |
| | | | | | Format | |
| | | | | | xxxx@xxxx.xxx | |
| 53 | Primary Point | Home | Text Box | Address will be | | Yes |
| | of Contact | Address 1 | | validated against | | |
| | | | | the USPS format | | |
| | | | | address | | |
| | | | | verification | | |
| | | | | process 950 | | |
| 54 | Primary Point | Home | Text Box | | | No |
| | of Contact | Address 2 | | | | |
| 55 | Primary Point | City | Text Box | | | Yes |
| | of Contact | | | | | |
| 56 | Primary Point | State | Drop-down | | Choices | Yes |
| | of Contact | | Selection | | will be: | |
| | | | Box | | 50 states | |
| | | | | | list | |
| 57 | Primary Point | Zip | Text Box | | | Yes |
| | of Contact | | | | | |
| 58 | Primary Point | Zip + 4 | Text Box | | | No |
| | of Contact | | | | | |
| 59 | Primary Point | Country | Drop-down | | Choices | Yes |
| | of Contact | | Selection | | will be: | |
| | | | Box | | Country list | |
| 60 | | Do any of | Radio | | Choices | Yes |
| | | the Principal | Button | | will be: | |
| | | Owners, | | | Yes | |
| | | Officers or | | | No | |
| | | Agents have | | | Don't | |
| | | a criminal | | | Know | |
| | | record? | | | | |
| 61 | | Contact | Text Box | | Email | No |
| | | Alternate | | | Address | |
| | | Email | | | Format | |
| | | Address | | | xxxx@xxxx.xxx | |

Next, address information will be collected from vendor RV and will be verified against the USPS format with address verification process 950, by an address information process 540 including the sub-processes headquarters 541 and remit 542. Table VI shows the different entries that are gathered with the address information gathering process 540. This data is stored as a data entry to vendor data database 50, and can be part of the vendor profile information.

TABLE VI

| | | | | | | Re- |
|---|---|---|---|---|---|---|
| Entry | Screen | Field | | | Vali- | quired |
| No | Placement | Name | Type | Comments | dation | Field |
| 1 | Headquarters | Address 1 | Text Box | | | Yes |
| 2 | Headquarters | Address 2 | Text Box | | | No |
| 3 | Headquarters | City | Text Box | | | Yes |
| 4 | Headquarters | State | Drop- | | Choices | Yes |
| | | | down | | will be: | |
| | | | Selection | | 50 states | |
| | | | Box | | list | |
| 5 | Headquarters | Zip | Text Box | | | Yes |
| 6 | Headquarters | Zip + 4 | Text Box | | | No |
| 7 | Headquarters | Country | Drop- | | Choices | |
| | | | down | | will be: | |
| | | | Selection | | Country | |
| | | | Box | | list | |
| 8 | Headquarters | Phone | Text Box | | | Yes |
| 9 | Headquarters | Fax | Text Box | | | No |
| 10 | Headquarters | Company | Text Box | | | No |
| | | Website | | | | |
| 11 | | Is your | Radio | | | Yes |
| | | Remit | Button | | | |
| | | Address | | | | |
| | | different | | | | |
| | | than the | | | | |
| | | Head- | | | | |
| | | quarters | | | | |
| | | address? | | | | |
| 12 | Remit | Address 1 | Text Box | | | Yes |
| 13 | Remit | Address 2 | Text Box | | | No |
| 14 | Remit | City | Text Box | | | Yes |
| 15 | Remit | State | Drop- | | Choices | Yes |
| | | | down | | will be: | |
| | | | Selection | | 50 states | |
| | | | Box | | list | |
| 16 | Remit | Zip | Text Box | | | Yes |
| 17 | Remit | Zip + 4 | Text Box | | | No |
| 18 | Remit | Country | Drop- | | Choices | Yes |
| | | | down | | will be: | |
| | | | Selection | | Country | |
| | | | Box | | list | |

Regarding the entry remit entries 12-18, the vendor RV can be asked by address information gathering process whether the remit address for payment processing and financial transactions is different from the headquarter address. For some industries, due to different financial transaction and consumer laws, the remit address may be in a different state as compared to the headquarters address. This allows to verify different records, for example records from different states, if there have been transactions under different records. Preferably, the address information gathering process 540 can request for more addresses than the ones indicated in Table VI. For example, for vendors being smaller entities, all the addresses that are associated with vendor can be requested, including but not limited to warehouse addresses, sales office addresses, manufacturing site or plant addresses, holding company addresses. For local contracting businesses related to building management and maintenance, the warehouse addresses could be mandatory for vendor registration. The gathered address data is later used for checking for proximity alerts between registered vendors RV₁ to RV₄.

Next, the diversity information process 550 can be performed, and the information gathered with this process is represented in Table VII below, including minority ownership information 551, veteran status 552, and small business ownership 553. Also, it may be possible to collect information on diversity of the workforce of a vendor, and a company having a higher diversity score can have increased productivity and creativity, increase language and communication skills, and have a positive reputations, and can have an impact on risks. Entry 2 allows to collect information on different types of minority statuses, for example membership to Women's Business Enterprise National Council (WBENC), state affiliation program membership, etc. This data can be stored as data entry of the vendor data database, also as part of the vendor profile information.

TABLE VII

| Entry | Screen | | | | | Required |
|---|---|---|---|---|---|---|
| No | Placement | Field Name | Type | Comments | Validation | Field |
| 1 | Minority | Are you | Radio | | Boolean | No |
| | Ownership | certified as a | Button | | (Yes/No) | |
| | Information | Minority | | | | |
| | | owned firm? | | | | |
| 2 | Minority | If so, by whom? | Radio | | Choices will be: | No |
| | Ownership | | Button | | State, WBENC | |
| | Information | | | | Affiliate and | |
| | | | | | Other, please | |
| | | | | | specify with the | |
| | | | | | ability to fill in the | |
| | | | | | information in a | |
| | | | | | Text Box | |
| 3 | Minority | If so, Which | Radio | | Choices will be: | No |
| | Ownership | ethnicity do | Button | | African American, | |
| | Information | you represent? | | | Asian-Indian | |
| | | | | | American, Asian- | |
| | | | | | Pacific American, | |
| | | | | | Hispanic | |
| | | | | | American, Native | |
| | | | | | American, Other, | |
| | | | | | please specify | |
| | | | | | with the ability to | |
| | | | | | fill in the | |
| | | | | | information in a | |
| | | | | | Text Box | |
| 6 | Minority | Are you | Radio | | Boolean | No |
| | Ownership | certified as | Button | | (Yes/No) | |
| | Information | Woman- | | | | |
| | | owned | | | | |
| | | business? | | | | |
| 7 | Minority | If so, by | Radio | | Choices will be: | No |
| | Ownership | whom? | Button | | State, WBENC | |
| | Information | | | | affiliate, Other, | |
| | | | | | please specify | |
| | | | | | with the ability to | |
| | | | | | fill in the | |
| | | | | | information in a | |
| | | | | | Text Box | |
| 8 | Veteran | Are you | Radio | | Boolean | No |
| | Status | Service | Button | | (Yes/No) | |
| | | Disabled | | | | |
| | | Veteran | | | | |
| | | Owned? | | | | |
| 9 | Veteran | Are you | Radio | | Boolean | No |
| | Status | Veteran | Button | | (Yes/No) | |
| | | Owned? | | | | |
| 10 | Small | Are you 8(a), | Radio | | Boolean | No |
| | Business | Small | Button | | (Yes/No) | |
| | Ownership | Disadvantage | | | | |
| | | Business of | | | | |
| | | HUBZone? | | | | |
| 11 | Small | Certification | Radio | | Choices will be: | No |
| | Business | Status | Button | | Active | |
| | Ownership | | | | Pending | |
| 12 | Small | Certification | Text | Calendar | Date Format: | No |
| | Business | Expiration | Box | Control | MM/DD/YYYY | |
| | Ownership | Date | | | | |

Many government organizations are required by law or policies to contract for and request bids from vendors having a certain minority status, for example being minority owned, being a small business, etc. Therefore, the diversity information gathering process 550 is a useful tool for government entities using system 10, such as local governments, state institutions, local agencies, municipalities that need to search and automatically credential such type of vendors. Also, entities that receive federal funds or state funds may also be required to give preference to vendors with minority status or use their best efforts to contract with such vendors, for example schools, hospitals, not-for-profit and non-governmental organizations.

Moreover, reference process 560 is performed to gather at least one reference for the vendor, summarized in Table VIII below. The vendor RV has the option to enter two or more references. The references must be a company or other organization that has previously engaged in business with RV, and at least one contact person of the reference company needs to be submitted. During the registration process, administrator AD of system 10 can request various information from the reference of vendor RV for verification purposes. Also, administrator AD or vendor RV themselves can request from the references a review that can be stored in the database of system 10, for review by users of system 10. This data can be stored as part of the vendor profile information as an entry to vendor data database 50, but can also be stored and classified as people information that can be part of the database entries for crosschecking with other vendors to detect relationships and also conflicts of interest. Therefore, this data can also be part of a separate database and index on people information.

TABLE VIII

| Entry | Screen | | | | | Required |
|---|---|---|---|---|---|---|
| No | Placement | Field Name | Type | Comments | Validation | Field |
| 1 | References | Company | Text Box | Button will be | | Yes |
| | | Name | | provided that | | |
| | | | | will allow | | |
| | | | | Vendors to | | |
| | | | | enter up to 2 | | |
| | | | | References | | |
| 2 | References | Address 1 | Text Box | | | Yes |
| 3 | References | Address 2 | Text Box | | | No |
| 4 | References | City | Text Box | | | Yes |
| 5 | References | State | Drop-down | | Choices will be: | Yes |
| | | | Selection | | 50 states list | |
| | | | Box | | | |
| 6 | References | Zip | Text Box | | | Yes |
| 7 | References | Zip + 4 | Text Box | | | No |
| 8 | References | Country | Drop-down | | Choices will be: | Yes |
| | | | Selection | | Country list | |
| | | | Box | | | |
| 9 | References | Phone | Text Box | | | Yes |
| 10 | References | Fax | Text Box | | | No |
| 11 | References | Contact | Text Box | | | Yes |
| | | First Name | | | | |
| 12 | References | Contact | Text Box | | | Yes |
| | | Last Name | | | | |
| 13 | References | Contact | Number | | | Yes |
| | | Phone | | | | |
| | | including | | | | |
| | | extension | | | | |
| 14 | References | Contact | Text Box | | Email Address | No |
| | | Email | | | Format | |
| | | | | | xxxx@xxxx.xxx | |

The registration step S20 is performed for gathering the information of Tables IV-VIII and is supported by graphical displays and information generated by vendor dashboard module 800 and registration module 500. During the registration step S20, vendor dashboard module 800 can display information related to the vendor profile summary, the completeness of the vendor profile information can be indicated in percentages, and a status message can be displayed informing vendor PV on the completion level of the application. The vendor profile summary can be an informative graphical user interface that can show a dashboard of profile sections that are blank, incomplete, or complete. An initial message can state New Applicant/Incomplete. Once all the required information has been provided to system 10 by registration module 500, and has been submitted with an electronic signature by the agent of PV, the status can indicate that vendor PV has now finished registration and will be released by supervisor SU of system, upon a positive review. It is also possible that the administrator AD of system 10 reviews and verifies the information provided by vendor PV, before PV is reviewed in step S30 and approved in step S40 to become a registered vendor RV₁ to RV₄. After completion of step S20, a confirmation e-mail can be sent to vendor PV indicating completeness of his profile, evoking e-mail notification module 300. Generally, upon log-in to system 10 by vendor PV or a registered vendor RV₁ to RV₄, a graphical user interface can be generated configured to summarize, display, review, edit, and add information that was gathered by the registration module 500 and the vendor registration process 510 and its sub-processes. Vendor dashboard module 800 can be used for displaying such vendor profile summary, and registration module 500 can be called upon for editing, modifying and adding data.

A change password component can be generated by account module 100, so that after log-in by a RV, a link can be displayed that evokes an interface for password change. The change password component can include three data items, being old password, new password, and a confirmation entry of the new password. The component will run a procedure to change the user's password once the collection of the three data items is complete. All three data items will be validated based on password rules, such as minimal length, old and new password must be different, new and confirmation password must be the same, and should not be the same as the last two passwords. Account module 100, upon login, will also notify the RV on the necessity of renewing the password on regular intervals, for example every six months or every year, and can evoke a graphical user interface that requires the changing of the password upon login. Also, account module 100 will have a log out component that will log the user off the vendor management system 10 and can clear all the session data.

By this process, vendor management system 10 has credentialed a vendor that allows a user to review vendors, and has sufficient information that allows user U to calculate risks and detect relationships that are related to conflicts of interest. In particular, with entries 23-26 of Table IV, relationships sub-process 522 can directly provide information that will allow user U of vendor management system 10 to have information on any officers, employees, or key personnel of vendor RV that are related to operators OP of system 10, or are even employed by operators OP of system 10. If such relationships exist, with sub-process 522 the registering vendor RV can enter names of employees of vendor management system, and their relationship to them, see entry 24, or can name the vendor companies, and their relationship to them, see entry 26. Regarding entries 27-31, sub-process 522 gathers information on whether the registering vendor was referred by a party to join the user of the vendor management system, and will gather information on the name of the referrer, and his employer, in the case of the health care industry.

However, with information gathered from Table V related to key personnel of the registering vendor RV, and access by the ERP access module to employee data of registering vendor RV, it is possible create a comprehensive vendor profile in vendor registration database 51, and to run a process that allows to discover relationships between RV and other registered vendors, or between RV and the operator OP, even in the registered vendor RV is not aware of such relationships.

FIG. 8 schematically depicts a flowchart of processes performed at system 10 when accessed by users U₁-U₂. First, for using system 10, a registered user needs to log in with login step T10. System 10 allows users U to register with registration module 500 similarly as described for vendor, and login, logout, and updates can be managed by account module 100. Next, user U will be presented with a graphical user interface that will show various functions to user U by user dashboard 400, for example functions to gather user registration data with user registration process 520 and its sub-processes. The graphical user interface is configured to provide functions for a user to update his account information such as but not limited to change of address, change of billing information for user U, change of contact person, in a step T26 for managing the account. User dashboard also provides administrative functions to user U, with a step T24 for administration his own account information. Also, the graphical user interface of user dashboard 400 presents functions to the user for searching and browsing for vendors with a searching/browsing step T20. For example, user U can browse different categories for example but not limited to industry classification, services or products offered, vendor business size categorization, for example, micro, small, medium, and large entity, local not local, international, non-international. In the example of the healthcare industry, user U can browse for different physician medicine specialties that are offered by vendors RV₁ to RV₄. Also, the graphical user interface can present functions to user U for searching for example as a search form, for searching vendor records. Table IX below list different search criteria, under filed name, that can be entered by user U for the search. The different field names presented in column 3 can also be used as criteria or parameters for browsing for different registered vendors RV₁ to RV₄.

TABLE IX

| Entry | Screen | | | | | Required |
|---|---|---|---|---|---|---|
| No | Placement | Field Name | Type | Comments | Validation | Field |
| 1 | Search | Legal Company | Text Box | | | No |
| | | Name | | | | |
| 2 | Search | DBA | Text Box | | | No |
| 3 | Search | Lawson ID | Text Box | | | No |
| 4 | Search | Lawson Vendor | Drop- | | Choices will be populated | No |
| | | Status | down | | from a Lawson Vendor | |
| | | | Selection | | Status lookup table, or by | |
| | | | Box | | using ERP/Lawson web | |
| | | | | | access 960 | |
| | | | | | Active | |
| | | | | | Inactive | |
| | | | | | Not in Lawson | |
| 5 | Search | FEIN/SSN | Text Box | | | No |
| 6 | Search | NAICS | Drop- | | | No |
| | | | down | | | |
| | | | Selection | | | |
| | | | Box | | | |
| | | | Combo | | | |
| 7 | Search | Vendor Status | Drop- | | Registered vendor RV | No |
| | | | down | | Registration in progress | |
| | | | Selection | | Registration under review | |
| | | | Box | | Registration approved | |
| | | | | | Registration not approved | |
| 8 | Search | Business | Drop- | | Choices will be: | No |
| | | Classification | down | | Distributor | |
| | | | Selection | | Retailer | |
| | | | Box | | Manufacturer | |
| | | | | | Service Provider | |
| 9 | Search | Services or | Text box | | | No |
| | | Products | | | | |
| | | offered | | | | |
| 10 | Search | Public or | Drop- | | Choices will be: | No |
| | | Private | down | | Public | |
| | | | Selection | | Private | |
| | | | Box | | | |
| 11 | Search | Region | Drop- | | Choices will be: | No |
| | | | down | | Local | |
| | | | Selection | | Regional | |
| | | | Box | | National | |
| | | | | | International | |
| 12 | Search | Diversity | Drop- | | All values will be from | No |
| | | | down | | lookup tables related to | |
| | | | Selection | | diversity. | |
| | | | Box | | | |
| 13 | Search | Risk Score | Drop- | | | No |
| | | | down | | | |
| | | | Selection | | | |
| | | | Box | | | |
| 14 | Search | Risk Status | Drop- | | Choices will be: | No |
| | | | down | | Minimal | |
| | | | Selection | | Moderate | |
| | | | Box | | High | |
| | | | | | Disqualified | |
| 15 | Search | Expiration Date | Text Box | Calendar | Date Format | No |
| | | | | Control | MM/DD/YYYY | |
| 16 | Search | Date of | Text Box | Calendar | Date Format | No |
| | | Registration | | Control | MM/DD/YYYY | |
| | | and Expiration | | | | |
| 17 | Search | Risk Criteria | Multiple | | EPLS (will grab | |
| | | | Selection | | those with EPLS | |
| | | | Box | | hits from EPLS | |
| | | | | | process 840) | |
| | | | | | Criminal | |
| | | | | | Bankruptcy | |
| | | | | | Multiple | |
| | | | | | Ownerships | |
| | | | | | Liens | |
| | | | | | Lawsuit Filings | |
| | | | | | Multiple | |
| | | | | | Address/Name | |
| | | | | | Relationship with | |
| | | | | | MHS Physicians, | |
| | | | | | Employees, BOD | |
| | | | | | (active and | |
| | | | | | inactive) | |
| | | | | | Vendor Risk | |
| | | | | | Profile | |
| | | | | | Local | |
| | | | | | Private | |
| | | | | | Interlocking | |
| | | | | | Ownership | |
| | | | | | Proximity Alert | |

Table IX indicates in the last column that none of the fields are required to be populated by user, so that broad searches can be entered by user U, generating long search result listings. FIGS. 9A and 9B represent an exemplary vendor search form 730 that is divided into a primary search form in FIG. 9A and a secondary search form 9B. Search form 730 can be generated as a graphical user interface allowing a user of system 10 to search for vendors based on the criteria represented in Table IX shown above. With company information search window 731, vendors can be searched directly for example by but not limited to company name, “doing business as” (DBA) being the name a business customarily uses, FEIN, SSN, whether the company is private or public, business classification indicating NAICS or based on another classification system, for example Standard Industrial Code (SIC), International Standard Industrial Classification (ISIC), based on a classification system internal to system 10 and operator OP, for example based on operator OP's ERP system, such as the Lawson™ vendor status, or another ERP-system based identification and vendor status. Internal classification can be whether vendor is a registered vendor RV₁-RV₄ that has been approved and released by system 10 for search and automatic credentialing, registration is in progress, registration is under review by analyst AN and supervisor SU for release, registration has been approved but not yet released, or the vendor is not registered or was not approved, vendor was terminated.

Moreover, risk information window 732 allows the user to choose and search for vendors based on risk status, risk scores and risk score ranges, risk criteria for example risks whether a vendor and one of its key people has a criminal record, bankruptcy risk, risk of non-payment, insurance risk. As an example in the healthcare industry, it is possible that physicians that are employed by registered vendor are checked on whether they have any sanctions on their record, have been sued for medical malpractice, and on their certifications. Next diversity information window 733 allows a user to select certain search criteria that is related to minority statuses, for example but not limited to whether the vendor is minority owned, veteran owned, service disabled veteran owner, woman owned, ethnicity, certain business classifications such as small entity, disadvantaged business, HUBzone program participation indicating businesses of historically underutilized business zones, for example geographic areas having few jobs, weak economic situation.

Date window 734 allows to search for different criteria related to dates and date ranges, for example registration date, being the date when the vendor has entered and submitted all the date for the vendor profile information for review by analyst AN and for releasing by supervisor SU, expiration date, being the date when a registered vendor's account expires, credentialing date, being the date on which the vendor has been released for automatic credentialing by users of the vendor management system 10, and allows the user to select these criteria by a checkbox, and to enter date ranges or time periods. Also, classification window 735 allows to set search criteria related to NAICS classification numbers, and multiple industry classification can be searched. Other search criteria that are now shown are environmental compliance criteria, whether vendor complies with International Standards Organization (ISO) 14000 standards, Environmental Protection Agency (EPA) standards compliance, family owned businesses, size of business, financial data, for example but not limit to profits, profits per share, assets-versus-liabilities ratio. User can reset the vendor search form 730 by clicking on a reset button 736, or can launch a search by clicking on a search button. Search results 736 can be presented in a table form.

Each time a search has been performed or user U has selected or entered a browsing criteria, a list of vendors are displayed that satisfy the search or the browsing criteria, or if no vendors can fulfill the criteria, user dashboard 400 will generate a display to user U that no vendors could be found based on the given criteria for searching or browsing. For every list vendors that is generated, the user U can click or otherwise select one or more vendors RV₁ to RV₄ for reviewing detailed information on the selected vendor with a vendor selection step T22 for example but not limited to reviewing risk information associated with the selected vendor, reviewing a company profile associated with vendor. Also, user U has the possibility to click a link, button or icon to recalculate risk information associated with selected vendor, in which the latest data will be taken into account, by triggering an automatic credentialing step S60. For this purpose, upon user U triggering or requesting the calculation of a new risk score, the web access module 900 is evoked to gather the latest data from the web services on the selected vendor. With the searching vendor records T20, users will be able to perform searches on different criteria within the vendor data.

Moreover, system 10 also allows for automatic and periodic updating of risks registered vendors RV₁ to RV₄. For example, a risk score and executive summary report 750 can be generated for all or a group of registered vendors RV₁ to RV₄ automatically, without any request or triggering by a user U. This can be done by system 10 on a regular basis, for example but not limited to daily, weekly, bi-weekly, every month, and the thus automatically calculated risk scores and executive summary reports can be stores and archived in a database. In a variant, at least one of the legal data access process 980 or the DUNS web service process 910 accessing Paydex scores, commercial credit scores, and financial stress scores can be periodically queried, for example but not limited to daily, weekly, bi-weekly, every month, and in case a change is detected, the risk score and the executive summary report can be updated for the specific vendor, together with a database entry on a time, date, and which event triggered the update or recalculation of the risk score and executive summary report. User dashboard 400 can provide functions to user U to access and display archived risk scores and executive summary reports. For example, the risk score history can be presented as a graph as a function of time, so that user U can discover changes in the credit scoring, for example a sharp drop of the credit score in the past, associated to a registered vendor. In a variant, multiple graphs can be shown as a function of time, to display the timely evolution of different risk criteria shown in Table XI, for example but not limited to Paydex score, commercial credit score, financial stress score, lawsuit filings, liens. Based on graphical representation on this history data associated with a vendor, user U can make informed decisions on his choice of vendors RV₁ to RV₄. For example, a user can decide not to choose a registered vendor for his contract because of a recent sharp drop in his score.

FIG. 10 depicts an exemplary graph showing the evolution of the risk score as a function of time, with the ordinate indicating the risk score, and the abscissa showing time. For user convenience, the graph can display horizontal lines to indicate the boundaries between minimal, moderate and high risks. In the variant shown, registered vendor RV₁ is subject to periodic updating of the risks associated to vendor, and the dates and risk scores are indicated along the graph RV₁ with a rounded dot and a horizontal line. Next, between time moments 5 and 6, an automatic event has triggered the calculation of the risk score, indicated by a square box and a label that indicates such. For example, step R18 has detected a change in the Paydex score that is above certain threshold, and this change has triggered the recalculation of the risk score. Also, between time moments 7 and 8, the risk score has been recalculated based on a user's request, and is indicated by a triangle at that time instance.

Next, Table X shows data items that are generated by user report generation step T30 of generating an executive summary report 750 on risk related to vendor RV₁ to RV₄ and viewing the report by user U. A graphical user interface is generated that presents the search results in a list. The search results can also be downloaded from system 10 in various data formats, such as an Excel sheet table XLS, a PDF document, an XML-based document, etc. by clicking and icon or a link.

TABLE X

| Entry | Screen | | |
|---|---|---|---|
| No | Placement | Field Name | Comments |
| 1 | Search | Legal Company | This column will list name with a “edit” link to modify |
| | Results | Name | vendor profile. Edit link will bring up the vendor record |
| | Grid | | in edit mode. All edits to vendor record by users U of |
| | | | system 10 will be written to the vendor audit history. |
| 2 | Search | Lawson ID and | Lawson ID/Status will be a lookup through a web ERP |
| | Results | Status | web process 960. |
| | Grid | | |
| 3 | Search | Risk Status | Minimal |
| | Results | | Medium |
| | Grid | | High |
| | | | Disqualified |
| 4 | Search | Vendor Status | Registered vendor RV |
| | Results | | Registration in progress |
| | Grid | | Registration under review |
| | | | Registration approved |
| | | | Registration not approved |
| 5 | Search | Registration | Expired |
| | Results | Expiration Status | Not Expired |
| | Grid | | |
| 6 | Search | Risk Criteria | Criminal |
| | Results | | Bankruptcy |
| | Grid | | Multiple Ownerships |
| | | | Liens |
| | | | Lawsuit Filings |
| | | | Multiple Address/Name |
| | | | Relationship with MHS Physicians, Employees, |
| | | | Vendor Risk Profile |
| | | | Local |
| | | | Private |
| | | | Paydex Score |
| | | | Credit Score |
| | | | Stress Score |
| | | | Interlocking Ownership |
| | | | Proximity Alert |
| | | | EPLS/OIG exclusion |
| 7 | Search | EPLS Outcome | EPLS Output from EPLS web process 940 with a link to |
| | Results | | modify individual result contents based on manual |
| | Grid | | review. |
| 8 | Search | Credentialing | Registered, marked for Release |
| | Results | Information | Display Registration Status |
| | Grid | | Date Marked for Credentialing |
| 9 | Search | Extend Vendor | Display current vendor expiration date with a link to |
| | Results | Expiration | extend date |
| | Grid | | |
| 10 | Search | Audit History | Display a link to the vendor registration audit history |
| | Results | | report |
| | Grid | | |
| 11 | Search | Link to Executive | Display a link to Executive Summary Report module. |
| | Results | Summary Report | Allow a user to select a report for executive review |
| | Grid | PDF | workflow. |
| | | Link to start | |
| | | executive review | |
| | | workflow | |

In the Entry 1 that lists the legal company name, it will be possible to click or select an icon or link that will allow user U to modify the vendor profile information, in a step T32 for editing vendor information. Once the edit link or icon has been selected, the vendor record will be shown in the graphical user interface in edit mode, and user U can make edits to the records of registered vendor RV₁ to RV₄. All edits to vendor profile information and vendor records by users U of system 10 will be written to the vendor audit history, providing a historic record of any changes with date stamp. With step T34 the user U can comment on vendor status and risk profile information, for example, specific comments can be entered and dated to put on the record, identifying the user U that left the comments. With step T36, a vendor RV₁-RV₄ can be selected for automatic credentialing. Also, step T38, a user U can initiate an executive review workflow of vendor RV₁-RV₄ so that supervisor SU of system can further review vendor information.

Step T40 is a step of logging in an administrator AD to system 10, and thereby administrator AD can perform an administration step T42. Access rights A42 are defined for administrator AD and are accessed for performing step T42. Step T42 can display a graphical user interface and underlying functions that are configured to allow administrator AD to maintain and update database accounts of user U and vendors PV and RV₁ to RV₄, and can perform other administrative functions such as software updates, changes to the graphical user interface, revisions to vendor profile information. Several administration functions will be available, such as the management of the role types of users U, global change to the vendor expiration date, management of vendor records, update and change the risk algorithm, modify system required fields for vendor profile, and review all audit trails of system 10. Only administrator AD will have the access right to modify risk algorithms and criteria calculation.

Step T50 is a step of logging in an analyst AN to system 10. Analyst AN can thereby perform an analysis step T52. Access rights A52 are defined for analyst AN in a table and are accessed when performing step T52. Analyst step T52 allows the analyst AN to analyze vendor accounts with the vendor profile information and their registration process, and can add, change, and remove risk criteria for risk score calculation based on analysis, can capture comments, audit stamp, and record, can select executive summary reports for supervisory review by supervisor SU for releasing vendors to become registered, can adds notes and conclusions with an electronic signature, and electronic signature confirmation will alert supervisor SU with a notification e-mail. Step T52 can display a graphical user interface and underlying functions that are configured to review and modify vendor information and the risk reports, for example the executive summary report 750, risk profile, or risk comparison table associated to particular vendors, and other reports. Other than vendors themselves, only analyst AN has the access right to modify vendor information. Next, step T60 is a step of logging in an supervisor SU to system 10. Supervisor SU can perform a supervision step T62 on system, and the access rights A62 are defined for supervisor SU in a table and are accessed when performing step T62. Supervisor SU can review executive summary reports, review comments and reports left by analyst AN, upload supporting documentation with respect to registered vendors, and add conclusions and approve or disapprove an electronic signature by analyst AN. With step T62, a graphical user interface and underlying functions are provided that are configured for allowing a supervisor SU to review and modify vendor information, risk reports, for example the executive summary report 750, risk profile, or risk comparison table associated to particular vendors, and vendor profile reports.

Table XI represents the different access rights A42, A52, and A62 and the ones for user U, and registered vendors RV₁ to RV₄ in a grid. The table entries with an X indicate the associated entity has access to perform the function or process of the first column.

TABLE XI

| | User | Analyst | Supervisor | Administrator | Vendor |
|---|---|---|---|---|---|
| Function | U | AN | SU | AD | RV |
| Vendor | | | | | X |
| Registration | | | | | |
| Modify Vendor | | X | | | X |
| Information | | | | | |
| Flag Vendor for | | X | | X | |
| Registration | | | | | |
| Vendor Status | | X | X | X | |
| View Risk Score | | X | X | X | |
| Information | | | | | |
| View | | X | X | X | |
| Detailed Risk | | | | | |
| Information | | | | | |
| View Partial Risk | X | | | | |
| Information | | | | | |
| Modify | | X | X | X | |
| Detailed Risk | | | | | |
| Information | | | | | |
| View Reports | X | X | X | X | |
| View Executive | | X | X | X | |
| Summary | | | | | |
| Report of | | | | | |
| vendor | | | | | |
| Administration | | | | X | |
| Change Vendor | | X | | X | |
| Expiration Date | | | | | |
| Modify database | | | | X | |
| (i.e. risk scores | | | | | |
| and algorithms) | | | | | |

For example, the user U could be a company looking for establishing a contractual relationship with one or more vendors, analyst AN could be a person at working with operator OP who is a certified public accountant (CPA) that is authorized to review, analyze, and verify vendor profile information of potential vendors PV. Supervisor SU can be a person or entity that is acting on behalf operator OP of the system 10, for example an executive or manager having certain level of decision making authority, and administrator AD is preferably an Information Technology (IT) officer of operator OP.

Next, FIG. 11 represents an exemplary vendor search results table 740 that can be shown in a window of the graphical user interface of vendor management system 10, after a search has been launched and the search results are returned, based on the data represented in Table X. The example of FIG. 11 shows three records that were returned related to plumbing vendors in a certain geographical area. In the first line, different criteria are shown, starting with company name, Lawson identification and status, risk status and score, vendor registration status, vendor registration expiration status, risk criteria, EPLS outcome, dates of registration, dates of vendor release for credentialing. The last three columns allow the user to extend vendor expiration, click or select a link to show audit history, and a link to show executive risk table 750 associated with the selected vendor.

Risk module 700 can perform various processes to calculate a risk score and other data related to vendor risk. An exemplary method with processes that are performed by risk module 700 is shown in FIG. 12, including vendor trigger step R02, user trigger step R04, a periodic trigger step R06, a comparison trigger step R10 that is based on periodic web services access step R08 and archive querying step R12. Also, the processes of risk module 700 include a data base access step R30, a relationship discovery step R35, a proximity discovery step R37, a normalization step R40, a score calculation step R50 that accesses a risk calculation algorithm and a weights for this purpose. Moreover, additional processes of risk module are a display step for visualizing calculated and estimated risks in a risk display step R60, a report generating step for generating and delivering various displayable, downloadable, and printable reports R62, and an archive step R64 for archiving data with time stamps for establishing a historic record for registered vendors RV₁ to RV₄.

Steps R02, R04, R06, and R10 describe different actions that cause the calculation of risk data associated to a vendor. Periodic trigger step R06 triggers the calculation and updating of the risk score that can be performed in regular intervals for one, a group, or all the registered vendors RV₁ to RV₄, user trigger step R04 is triggered by user U that is logged into system 10 usually for a specific vendor, and vendor trigger step R02 can be triggered by vendor RV₁-RV₄ themselves for their own risk scoring, and comparison trigger step R10 can be triggered by external events that can be detected by accessing data with periodic web services access step R08 via web services module 900 for a specific vendor, and comparing this data with pre-existing date from the registered vendor by archive querying step R12, to gather stored data from databases 50-52 on vendors. Once any one of these steps has triggered the calculation and updating of the risk score, the method moved to the database access step S20 for accessing various external data the web access module 900, to update all the information on the selected vendor, and then passes on to database access step R30 for accessing the databases 50-52 that are internal to system 10. In case the trigger is originated from comparison trigger step R10 it is not necessary to access the web services 900 again.

Once all the necessary data has been acquired, the relationship discovery step R35 can be performed for the selected vendor to search and identify relationships, and proximity discovery step R37 can be performed to discover suspicious geographic proximities between the selected vendor, other registered vendors RV₁-RV₄, and operating vendor OP. Some of the data from the relationship data and the proximity data can be used to calculate the risk score, in particular a relationship between registered vendor and operating vendor to show conflicts of interest, or the presence of vendors RV₁-RV₄ that are de facto or de jure not acting as independent entities. The information that are passed from step R30 and R35 to the normalization step R40 are values related to the risk criteria summarized in Table XII.

TABLE XII

| | |
|---|---|
| Entry No. | Parameter |

| | |
|---|---|
| 1 | Criminal |
| 2 | Bankruptcy |
| 3 | Multiple Ownerships |
| 4 | Liens |
| 5 | Lawsuit filings |
| 6 | Multiple address/name |
| 7 | Relationship with |
| 8 | Local |
| 9 | Private |
| 10 | Paydex Score |
| 11 | Commercial Credit Score |
| 12 | Financial Stress score |
| 13 | EPLS/OIG |

Normalization step R40 and risk score calculation step R50 take multiple risk criteria under account, and the use of risk criteria 1-12 of Table XII are preferred, but are not exclusive, and other risk criteria can also be used, for example but not limited to financial data of selected vendor, independent resources reviewing business reputation of selected vendor, proximity alerts, suspicious bid alerts. Normalization step R40 can normalize all the values for the risk criteria to a uniform range to be comparable with each other, and then risk score is calculated in risk score calculation step R50 based on the normalized values that are provided from step R40, by accessing a score calculation algorithm and weights associated to each criteria. In risk score calculation step R50, weighted scores are generated from the normalized scores based on weights, to generate the high weighted score (HWS) entries of risk calculation table, an exemplary table shown with Table XIII below. In the exemplary embodiment shown in Table XIII, the scores are represented in a range from 0 to 50, with 0 representing no risk associated to this value, and 50 representing maximal risk associated to this value. For each risk criteria, a different weight is used, all the weights summing up to 1, and all the HWS summing up to 50.

In column 4 of Table XIII below, exemplary weighting factors are shown, with the criminal status of the vendor having the strongest weight representing 22% of the importance to the risk score determination, and with the existing liens having the lowest weight of 1% in the importance of the risk score determination. Regarding Entry Number 7 related to relationships, different types of relationships can be discovered and analyzed, for example relationships of between a selected vendor and a registered vendor RV₁ to RV₄, and relationships between selected vendor and operator OP of system 10 if he is himself registered as a vendor, being an operating vendor. In case such relationship is discovered, the risk score is increased as indicating more risk associated to the selected vendor. Also, the weight values shown in Table XIII are typical weight values that can be used in the health industry, below may also be industry specific. For example, to choose a vendor in the form of a contractor for a construction business project, the weights may be different. For example, parameter 7 related to relationships weighs heavy for the health industry with 17% due to conflicts of interest, but may weigh less for the construction business sector, where family relationships between businesses are more common.

TABLE XIII

| Entry | | | | High weighted |
|---|---|---|---|---|
| No | Risk Criteria | Score | Weight | Score (HWS) |
| 1 | Criminal | 0 = 0 | 0.18 | 8.90 |
| | | >=1 = 50 | | |
| 2 | Bankruptcy | Yes = 50 | 0.09 | 4.45 |
| | | No = 0 | | |
| 3 | Multiple Ownerships | 0 = 0 | 0.06 | 3.08 |
| | | 1-10 = 50 | | |
| | | >=11 = 25 | | |
| 4 | Liens | 0 = 0 | 0.01 | 0.34 |
| | | 1-2 = 25 | | |
| | | >=3 = 50 | | |
| 5 | Lawsuit filings | 0 = 0 | 0.01 | 0.68 |
| | | 1-2 = 25 | | |
| | | >=3 = 50 | | |
| 6 | Multiple address/name | 0 = 0 | 0.05 | 2.40 |
| | | 1-10 = 50 | | |
| | | >=11 = 25 | | |
| 7 | Relationship with | 0 = 0 | 0.14 | 6.85 |
| | | >=1 = 50 | | |
| 8 | Local | 0 = 0 | 0.08 | 4.11 |
| | | >=1 = 50 | | |
| 9 | Private | Yes = 50 | 0.04 | 2.05 |
| | | No = 0 | | |
| 10 | Paydex Score | <=59 = 50 | 0.05 | 2.74 |
| | | 60-69 = 25 | | |
| | | 70-79 = 15 | | |
| | | >=80 = 0 | | |
| 11 | Commercial Credit Score | 0-2 = 0 | 0.05 | 2.40 |
| | | 3 = 15 | | |
| | | 4 = 25 | | |
| | | 5 = 50 | | |
| 12 | Financial Stress score | 0-2 = 0 | 0.06 | 3.08 |
| | | 3 = 15 | | |
| | | 4 = 25 | | |
| | | 5 = 50 | | |
| 13 | EPLS/OIG | 0 = 0 | 0.18 | 8.90 |
| | | >=1 = 50 | | |
| | Total | | 1.0 | HWS = 50 |

The calculated risks can be minimal, indicated by a score range of 0-5, moderate indicated by score range between 6-20, and high indicated by a score range from 21-50, or disqualified. The disqualified risk status can be based on the EPLS results and decision by operator OP of system 10, for example by analyst AN. It is also possible that analyst AN creates a record in the registration data of a vendor RV₁ to RV₄ to indicate disqualification, and the reason for this decision.

A preferable risk score calculation algorithm consists of weighting the scores by multiplication, and then by adding all scores 1-12 together, to create the risk score. However, other algorithms can be used to create risk score with score calculation step R50. The risk calculation algorithm of step R50 and the normalizing of step R40 can be implemented as an SQL package containing two different SQL procedures. One procedure will be configured to output the risk score associated with a selected vendor, and the other procedure will be configured to enable, disable or change the risk criteria list, risk score calculation algorithm, and weight per criteria. This allows an administrator AD can modify this algorithm for adaption, optimization, and to take into account information on risk that is gathered by system 10, for further improvement of the risk algorithm and criteria calculation.

For example, additional risk criteria can be added or deleted from list, weights can be changed, and the algorithm altered. Because the risk score calculation algorithm can be set to be global for all the vendors RV₁ to RV₄, any change in this algorithm will affect all the records of registered vendors RV₁ to RV₄. Accordingly, upon changes made by AD to the weights, list of risk criteria, and algorithm, it is possible that system 10 will trigger a global risk score update for all registered vendors RV₁ to RV₄, taking the new weights, risk criteria, and algorithm into account. Alternatively, it is possible that based on industry experience and standards, the risk score calculation algorithm, weights, and list of risk criteria are selected to be different for different types of industries. For example, when selecting suppliers for electronic components in the electronics manufacturing industry, long-term contracts with vendors can be desired and the financial security of these vendors is important. Therefore, for such industry, different weights and risk criteria can be chosen.

Next, the risk display step R60 and the report generating step R62 can generate data that the user U can review and archive related to the scores. Risk display step R60 can generate a graphical user interface for user dashboard 400 related to risk, including executive risk report 750, risk score, relationship diagram such as a spider diagram SD on relationships, relationship alerts, proximity diagram, for example as a spider diagram, proximity alerts, risk profile, and comparative risk profile, warning flags on vendor issues, and report generating step R62 can generate savable and printable documents for the same data. These steps R60 and R62 receive score data including risk score from score calculation step R50, but also from web services access step R08, R20 and database access step R30. Also, steps R60 and R62 of can evoke reporting module 600 for this purpose. Report generating step R62 can also deliver executive summary reports to the person that is registered by user U to receive the reports, for example an executive or an agent, and can also deliver reports to the accounting department or accounts deliverable of user U, for example by evoking the e-mail notification module 300. Moreover, a step R64 can format the data for storage and archiving in databases 50-52 to create a historic record related to registered vendors.

Comparison trigger step R10 can be triggered by various events. For example, it is possible to define a trigger threshold for a risk criteria that would require an automatic recalculation of the risk score, to trigger the recalculation if any of the financial scores changes by a pre-defined threshold as compared to the stores data related to registered vendors RV₁-RV₄. This could be the case if the Paydex™ score changes by five points, if the commercial credit score changes by one point, or if the financial stress score changes by one point. Other events that could create a comparison trigger with step R10 could be the detection of legally significant events related to registered vendors RV₁-RV₄ when accessed by legal data access process 980, or changes in financial data such as the detection of net operating losses by financial data access process 990 if registered vendors RV₁-RV₄ have made profits before. Comparison trigger step R10 will only trigger a recalculation of the risk score for the vendors that are concerned by that change.

Relationship discovery step R35 of the risk module 700 performs an algorithm that searches and matches individuals that are related to the selected vendor with individuals stored in records of registered vendors RV₁ to RV₄ in vendor data databases 50, but can also take records of user database 51 into account. As discussed above, separate databases or database entries may have been created for the people information, with a separate database index, so that people information can be more efficiently matched. For example, it is possible to discover if officers O, employees E, board B, and owners OW of a selected vendor have a relationship or are the same as O, E, B, and OW of other registered vendors RV₁ to RV₄, but also if any O, E, B, and OW of operator OP has a relationship or are the same as O, E, B, and OW of the selected vendor. This allows to determine independence of registered vendors RV₁ to RV₄ from each other, that can be used to detect fraudulent bidding schemes. For operating vendor OP, unlike for registered vendors RV₁ to RV₄, it is possible to have an updated and full list of all employees due to ERP web access module 960. This can factor into the relationship risk criteria, and the risk score, because it can discover conflicts of interests. It is also possible that relationship discovery step R35 performs searches that are limited to vendors that are active within the same NAICS industry classification, or that are located in a defined geographic area, for example by defining a maximal distance between the headquarters or offices of these businesses, to narrow the search and avoid confusions. For example, in an application to the healthcare industry, operator OP may be running system 10, but at the same time may be an employer or having another closer relationship to different physicians, experts, directors and executives as employees, and these persons may at the same time have a relationship to registered vendors RV₁ to RV₄, for example by a family relationship. The search can be limited to the NAICS code of the healthcare industry. Also, it may be possible that a physician is contracted with two different vendors RV₁ and RV₂ to offer his services. The same may be the case between different vendors themselves. Historical database records of vendors RV₁ to RV₄ can be maintained to include inactive or past employees E, officers O, board B, and these database entries can be refreshed at a regular interval, for example bi-weekly or monthly, so that these relationships are kept up to date.

The algorithm of the relationship discovery step R35 is configured to search for exact matches based on first name and last name and if possible other available data, and in case a relationship is found, a relationship risk criteria can be associated with an indication of active or inactive status of the relationship, so that user U can make informed decisions on such risk. It is also possible that multiple ownerships can also be discovered by algorithm, preferably based on Thomson Reuters™ data that has been queried and received via legal data access process 980 that can access legal and company registration information. For querying and accessing this data, legal data access process 980 can be used at time the algorithm of the relationship discovery step R35 analyzing the multiple ownership discovery, so that latest changes are up-to-date.

An exemplary relationship diagram as a spider diagram SD on relationships is shown in FIG. 13 that can be generated after the algorithm of the relationship discovery step R35 has discovered relationship issues related to the selected vendor. The spider diagram can be generated by display step R60 for display on the screen, or by step R62 to be included in printable report. In this diagram, four different registered vendors RV₁ to RV₄ are represented, with vendors RV₂ and RV₃ having a common owner Oₓ, and having a common employee E₁₂. For example, employee E₁₂ can be a physician that has contracted to offer his services on a part-time basis with two different vendors RV₂ and RV₃. Also, it is also shown that vendor RV₃ has an additional, different owner O_{y}. Also, spider diagram SD shows that employee E₃ from vendor RV₃ and employee E₄ from vendor RV₄ are spouses, and officer O₂ of vendor RV₂ is the parent of employee E₁ of vendor RV₁. Next, it is also indicated with the arrow pointing upwards that vendor RV₁ is actually owned by the operator OP of the system. For example, a user U that selects and analyses vendor RV₁ for evaluation by system 10 will discover that vendor RV₁ is actually owned or in another relationship by operator OP of system 10, and will also see that one of its employees E₁ has a family relationship with vendor RV₂. The presence of such relationships can create a ‘relationship alert’ that can be made aware to user U by prompts or flags on graphical user interface by step R60, can be indicated in reports generated by step R62, or can influence the risk score by increasing the risk in risk calculation step R50.

Next, FIG. 14 shows a relationship diagram that can be displayed by step R60 or generated into a report by step R62 depicting interlocking ownership relationships between registered vendors RV₁ to RV₅. On their face, the vendors RV₁ Bill Smith Plumbers, RV₂ Smith Plumbing Contractors, RV₃ Flynn Pluming Co., RV₄ Ultimate Plumbing, and RV₅ JBA Piping all appear to be independent plumbing contractors. However, because the registration process has required RV₁ to RV₅ to identify their owners, by relationships sub-process 522 and people information process 530, different individuals could be identified and matched showing interlocking ownerships. For example, the individual “William Smith” has been identified as being an owner of RV₁, RV₂, RV₃, and RV₄, the individual “Mike Johnson” has been identified as owner of both RV₂ and RV₄, and the individual “Josh Ogle” has been identified as owner of both RV₄ and RV₅. The same searching and matching can be done for family members, based on spousal relationships, children, sibling, parents. These relationships can be displayed by a graphical user interface showing relationship connections R, double relationship connections DR, and other multiple-ownership connections.

In the context of FIG. 14, it is possible that a user U has received five different bids from vendors RV₁ to RV₅ for a plumbing project at a major construction site, and at that time these vendors are not yet registered to system 10. User U then requires that all vendors RV₁ to RV₅ that are part of the bidding to register at system 10 for risk analysis purposes. As a consequence, all vendors RV₁ to RV₅ have become registered with system 10 after going through steps S10-S40 shown above. Also, user U has requested operator OP of system 10 that he releases these vendors so that user U can select these vendors for automatic credentialing. Once user U receives the relationship diagram, he will see that at least RV₁ to RV₃ are controlled by the same individual, and that RV₄ and RV₅ have some interlocking ownerships with RV₁ to RV₃. This information informs user U that no independent bids have actually been received, and can be used to prevent bid rigging and other anti-competitive behavior.

Next, proximity discovery step R37 of the risk module 700 performs an algorithm that searches and matches addresses provided by the selected vendor with addresses stored in records of registered vendors RV₁ to RV₄ in vendor data databases 50, to see if there are common addresses that would raise the presumption that two different vendors actually may not be independent. Addresses are gathered by the address information process 540 by step S20.2. For example, it may be discovered that a plumber A has an office address that is the same as an office or warehouse address of plumber B. Step R37 can be performed based on a pre-selection of an industry classification of the vendors based on the NAICS codes, to limit the proximity matching to the same sector of activities. This algorithm is performed based on addresses that have been gathered from vendors in the registration step S20, for example from address gathering process 540, including but not limited to headquarters addresses, addresses of operations, warehouse addresses. Also, these addresses may have been verified by the USPS web service 950. In a variant, proximity discovery step R37 can also search and discover addresses of individuals E, 0, B, of registered vendors and operating vendor OP to find cross-matches of addresses of these individuals between different vendors. The presence of such proximities between vendors RV₁-RV₄ can create a ‘relationship alert’ that can be made aware to user U by prompts or flags on graphical user interface by step R60, can be indicated in reports generated by step R62, or can influence the risk score by increasing the risk in risk calculation step R50. Moreover, the relationship diagram also shows suspicious bid flags SBF or suspicions bid history flags that are associated to vendors RV₁-RV₃ provided by bid management module 1100. As further discussed below, the SBF indication shows to user U the increased probability that vendors RV₁-RV₃ have engaged in a bid rigging scheme, due to similarity of bids, or suspicious bidding history.

FIG. 15 depicts an exemplary relationship diagram that can be displayed by step R60 or generated into a report by step R62 depicting proximity issues that can be generated by display step R60. In this diagram, three (3) registered vendors RV₁-RV₃ are represented, with vendor RV₁ sharing the same business address BI with RV₃ indicated by a proximity relationship PA₁ in the form of a connecting arrow, and vendor RV₁ sharing the same business address BI with the warehouse address WA of vendor RV₂ indicated by a proximity relationship PA₂. Also, all three vendors are part of the same industry classification code 32 under the NAICS system. Moreover, system 10 allows to display a map, for example by using MapQuest™, GoogleMaps™ or BingMap™ applets, to display these addresses on the display for user review. Based on this information, the user can make an informed decision on the detected proximities.

FIG. 16 depicts a screenshot from an exemplary executive risk table 750 that can be generated by report generating step R62. For each registered vendor, the vendor management system 10 uses risk module 700 to generate the risk score, but populates the remaining data filed of the executive risk table 750 with data gathered from web services access step R20 and database access step R30 for information on registered vendors. The executive risk table 750 is associated with an individual registered vendor RV₁-RV₄ and summarizes different risks and associated information in table 750. The first lines of table 750 show identification information 751 the vendor's name, the address, the Lawson™ identification number and whether the Lawson status is active, registered agents, principal officers, principal owners, whether the vendor is private or public, whether the vendor is local or remote geographically. Next, table 750 presents general risk information 752 that includes the risk score calculated by risk score calculation step R50, and the risk audit trail with details and dates on risk score generation events and accesses by users, associated with respective dates.

Next, Dun & Bradstreet™ information 753 is presented, showing the line of business, the Paydex™ score on a scale from 0-100, commercial risk score on a scale from 0 to 5, financial stress score on a scale from 1-5. Legal and registration information is shown in legal history information 754, for example legal and registration information that has been gathered by Thomson Reuters™, including a number of name variations, a number of address variations, number of liens, number of lawsuit filings, criminal records, any past or present bankruptcy proceedings, existence and parties to multiple ownership. Next, executive risk table 750 includes related entities information 755, including the presence and entities of an interlocking ownership, relationships of the vendor to the user's entity, for example to physicians or employees of the user's entity. This information can be generated as a spider diagram SD to visually show these interrelationships. Table 750 then includes a window 756 that allows to browse, select, and upload supporting documents, and different types of supporting documents can be selected, for example but not limited to audit reports, analyst comments. Moreover, table 750 has an analyst notes section 757 that allows an authorized analyst of the vendor management system to add notes 758 in text form, and these notes can be marked by a checkbox 759 for supervisory review.

Next, Table XIV shows an exemplary risk profile that has been generated for a particular vendor. These scores are also represented in the executive summary report 750 shown in FIG. 16. In the first column from the left, risk criteria 1-12 are listed, with the second column indicating the lowest score for each risk criteria, the fifth column indicating the highest score for each risk criteria, and the third and fourth column indicating middle scores for each risk criteria. Sixth column indicates the weight used for the calculation of the score, and columns seven to nine show weighted scores 1 and 2, and the final weighted score. Also, in the last three lines of Table XII the risk categories are indicated, being minimal risk, moderate risk, and high risk, as well as the score ranges that are associated to each category.

TABLE XIV

| | Lowest | Middle | Middle | Highest | | W. Score | W. Score | Weighted |
|---|---|---|---|---|---|---|---|---|
| Risk Criteria | Score | Score (1) | Score (2) | Score | Weight | (1) | (2) | Score |
| Criminal | 0 | 0 | 0 | 50 | 0.18 | 0.00 | 0.00 | 8.90 |
| Bankruptcy | 0 | 0 | 0 | 50 | 0.09 | 0.00 | 0.00 | 4.45 |
| Multiple | 0 | 0 | 25 | 50 | 0.06 | 0.00 | 1.54 | 3.08 |
| ownerships | | | | | | | | |
| (Analyst | | | | | | | | |
| notebook-complex | | | | | | | | |
| structure) | | | | | | | | |
| Liens (Includes | 0 | 0 | 25 | 50 | 0.01 | 0.00 | 0.17 | 0.34 |
| Corp/Tax) | | | | | | | | |
| Lawsuit Filings | 0 | 0 | 25 | 50 | 0.01 | 0.00 | 0.34 | 0.68 |
| Multiple | 0 | 0 | 25 | 50 | 0.05 | 0.00 | 1.20 | 2.40 |
| Address/Name (not | | | | | | | | |
| publicly traded) | | | | | | | | |
| Relationship With | 0 | 0 | 0 | 50 | 0.14 | 0.00 | 0.00 | 6.85 |
| Physician, | | | | | | | | |
| employees, | | | | | | | | |
| vendors risk- | | | | | | | | |
| profile | | | | | | | | |
| Local | 0 | 0 | 0 | 50 | 0.08 | 0.00 | 0.00 | 4.11 |
| Private | 0 | 0 | 0 | 50 | 0.04 | 0.00 | 0.00 | 2.05 |
| Paydex Score | 0 | 15 | 25 | 50 | 0.05 | 0.82 | 1.37 | 2.74 |
| Credit | 0 | 15 | 25 | 50 | 0.05 | 0.72 | 1.20 | 2.40 |
| Stress | 0 | 15 | 25 | 50 | 0.06 | 0.92 | 1.54 | 3.08 |
| EPLS | 0 | 0 | 0 | 50 | 0.18 | 0.00 | 0.00 | 8.90 |
| | | | | | 1.00 | 2.47 | 7.36 | 50.00 |
| Minimal | 0 to 12 | | | | | | | |
| Moderate | 13 to 30 | | | | | | | |
| High | 31 to 50 | | | | | | | |

Moreover, with risk module 700, risk results of two different risk categories can be directly compared in a paired risk comparison table that can be displayed by the graphical user interface or generated as a report, represented below in Table XV. It is thereby possible to directly compare risk value and showing their difference, categorizing in minor differences 1, medium differences 2, and major differences 3. For row C1 column C2, if Row C1 is more important than C2 than enter C1, 1; C1,2; C1,3 as appropriate. If C2 is more important than enter C2, 1; C2, 2; C2, 3. Repeat for Row C1/C3 etc. Each parameter is given a +1 arbitrary score if the least important criterion has a zero.

TABLE XV

| | C1 | C2 | C3 | C4 | C5 | C6 | C7 | C8 | C9 | C10 | C11 | C12 | C13 | |
|---|---|---|---|---|---|---|---|---|---|---|---|---|---|---|
| C1 | | C1, 1 | C1, 2 | C1, 3 | C1, 3 | C1, 2 | C1, 1 | C1, 1 | C1, 3 | C1, 3 | C1, 3 | C1, 3 | C13, 1 | |
| (Criminal) | | | | | | | | | | | | | | |
| C2 | | | C2, 1 | C2, 1 | C2, 1 | C2, 1 | C2, 1 | C2, 2 | C2, 2 | C2, 1 | C2, 1 | C2, 1 | C13, 2 | |
| (Bankrupt) | | | | | | | | | | | | | | |
| C3 | | | | C3, 3 | C3, 2 | C3, 1 | C7, 1 | C8, 1 | C3, 2 | C10, 2 | C11, 2 | C12, 2 | C13, 2 | |
| (Mult. | | | | | | | | | | | | | | |
| Own) | | | | | | | | | | | | | | |
| C4 | | | | | C5, 1 | C6, 2 | C7, 3 | C9, 1 | C9, 2 | C10, 2 | C11, 2 | C12, 2 | C13, 3 | |
| (Liens) | | | | | | | | | | | | | | |
| C5 | | | | | | C6, 1 | C7, 3 | C8, 3 | C9, 2 | C10, 1 | C11, 1 | C12, 1 | C13, 3 | |
| (Lawsuit) | | | | | | | | | | | | | | |
| C6 | | | | | | | C7, 1 | C8, 1 | C9, 1 | C6, 1 | C6, 1 | C6, 1 | C13, 2 | |
| (Mult | | | | | | | | | | | | | | |
| Add.) | | | | | | | | | | | | | | |
| C7 | | | | | | | | C7, 1 | C7, 1 | C7, 3 | C7, 3 | C7, 3 | C13, 2 | |
| (Relation) | | | | | | | | | | | | | | |
| C8 | | | | | | | | | C8, 2 | C8, 1 | C8, 1 | C8, 1 | C13, 2 | |
| (Local) | | | | | | | | | | | | | | |
| C9 | | | | | | | | | | C10, 1 | C11, 1 | C12, 1 | C13, 2 | |
| (Private) | | | | | | | | | | | | | | |
| C10 | | | | | | | | | | | C10, 1 | C12, 1 | C13, 2 | |
| (Paydex) | | | | | | | | | | | | | | |
| C11 | | | | | | | | | | | | C12, 1 | C13, 2 | |
| (Credit) | | | | | | | | | | | | | | |
| C12 | | | | | | | | | | | | | C13, 2 | |
| (Stress) | | | | | | | | | | | | | | |
| C13 | | | | | | | | | | | | | | |
| (EPLS) | | | | | | | | | | | | | | |
| Score | 26 | 13 | 9 | 1 | 2 | 7 | 20 | 12 | 6 | 8 | 7 | 9 | 26 | 146 |
| Weight | 18% | 9% | 6% | 1% | 1% | 5% | 14% | 8% | 4% | 5% | 5% | 6% | 18% | 100% |
| (%) | | | | | | | | | | | | | | |

Based on the calculated risks that can be presented to user U by executive summary report 750, risk profile as shown in Table XIV, and risk comparison table XV, vendors RV₁-RV₄ can be chosen as a contracting party. Users have the choice of using vendors with higher risk based on subjective criteria, but also in a case of sole source vendors

The use of vendor management system 10 presents several substantial advantages over the conventional systems, and can be used to detect various fraud and abuse schemes that vendors may have engaged into. For example, by relationship discovery, it is possible for vendor management system 10 to detect bid rigging schemes. In a bid rigging scheme, two or more vendors can conspire to steer a company's purchase of goods and services through different types of bid rigging. For example, a bid-rotation scheme calls for all participating vendors to submit bids while taking turns as the low bidder. Under a bid-suppression scheme, two or more vendors illegally agree that at least one of the vendor-participants will withdraw a previously submitted bid or not bid at all, the intent is to ensure acceptance of one particular bid. Moreover, complementary bidding is marked by competing vendors submitting token bids with a high price or special terms that will make them unacceptable to the company. For example, if four (4) vendors have submitted exactly the same amount or conditions for the sale of goods or services, or with minor insubstantial differences, and it appears that there is interlocking relationships between these four (4) vendors, there is a very high probability that these bids are the result of a conspiracy between the vendors.

Therefore, users U₁-U₂ can first analyze bids that are received from vendors RV₁ to RV₄ by the bid management tool 1100. Bid management tool 1100 can then identify similarities between different bids, for example similar bid amounts for goods and services, similar bid conditions, such as delivery terms, warranties, quality of goods delivered, insurance guarantees, hold-harmless clauses. Such conditions of the bids can be entered by users U₁-U₂ via the bid management tool 1100 to system 10 for analysis and identification of bids that have an increased possibility of being subject to a fraud scheme, for example by entering all relevant bid information and to create a bidding history for registered vendors. Next, bids from vendors RV₁ to RV₄ that have any or at least a certain threshold of similarities can be flagged as being suspicious for further review, and bid histories from vendors RV₁ to RV₄ can be compared to detect bid-rotation and bid-suppression, and suspicious vendors can be tagged. Vendors RV₁ to RV₄ that are flagged for having suspicious bid histories, or have made bids that are flagged for being suspicious, can be brought to the users U_{I}-U₂ attention, for example by using a graphical user interface provided by user dashboard 400 and reporting module 600.

Next, users U₁-U₂ can select vendors RV₁ to RV₄ that are flagged for having suspicious bids and bid histories with the SBF flag, and the automatic credentialing can be performed on them, with step S60, including relationship discovery step R35, proximity discovery step R37, and score calculation R50. The results of the proximity discovery step R37, but even more the results of the relationship discovery step R35 will show connections between vendors RV₁ to RV₄ that had presented bids that have been flagged as suspicious, for example by discovering interlocking ownerships. Users U₁-U₂ will be able to see if there is a correlation between relationships, proximities, and flagged bids. Also, risk module 700 can be used to show a relationship diagram showing relationships between vendors, proximities between vendors, and bids of vendors that were flagged for being suspicious. In a variant, vendors RV₁ to RV₄ that have been flagged for suspicious bids and bid histories can be an additional factor of the risk criteria for calculating the risk score, and the risk score can be raised with score calculation R50, indicating higher risk, if vendors RV₁ to RV₄ have been flagged for suspicious bid and bid histories. Also, the fining of a correlation between discovered relationships between vendors RV₁ to RV₄ and flagged vendors RV₁ to RV₄ on suspicious bids and bid histories can increase the risk score.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. A vendor management system for calculating risks associated with registered vendors, comprising:
a processing device including at least one hardware processor configured to operate a risk calculation module to perform a risk analysis associated with a vendor of the registered vendors;
a user terminal for accessing the processing device by a user, the user terminal configured to generate a user interface for the user to select a vendor from a list of registered vendors and to display a result of a risk analysis including a risk score performed by the risk calculation module; and
a database access device configured to access data on the registered vendors including an access to a first database entry storing a vendor profile information including risk criteria associated with vendors, a second database entry storing personnel information of the vendors including information on at least one of employees and directors, and a third database entry storing weight factors associated with the risk criteria.

2. The vendor management system according to claim 1, wherein the risk analysis performed by the risk calculation module calculates the risk score based on relationships between at least one of the employees and the directors between at least two registered vendors based on the weight factors.

3. The vendor management system according to claim 1, further comprising:
a web access device configured to access web data services for gathering information related to the risk criteria of the registered vendors.

4. The vendor management system according to claim 3, wherein the web access device is further configured to access legal history information, a Paydex score, and a commercial credit score of the registered vendors.

5. The vendor management system according to claim 2, wherein
the vendor management system is operated by an operating vendor, and the operating vendor is a registered vendor; and
wherein the calculation of risk score based on relationships increases the risk score in case a relationship between at least one of the employees and the directors between a vendor and the operating vendor is detected.

6. The vendor management system according to claim 3, wherein
the user terminal is configured to allow the user to trigger the risk analysis, and upon triggering the risk analysis, the web access device accesses the web data services to update the information.

7. A vendor management method for calculating risks associated with registered vendors, comprising the steps of:
selecting a vendor from a list of the registered vendors via a user terminal;
accessing data on the registered vendors by a data base accessing device, the accessing including access to a first database entry storing a vendor profile information including risk criteria associated with vendors, a second database entry storing personnel information of the vendors including information on at least one of employees and directors, and a third database entry storing weight factors associated with the risk criteria;
performing a risk analysis associated with the selected vendor based on the data of said step of accessing with a risk calculation module that is operated on a processing device including at least one hardware processor, to generate a risk score; and
displaying a result of the risk analysis including the risk score associated with the selected vendor.

8. The vendor management method according to claim 7, wherein said step of performing the risk analysis calculating the risk score is based on relationships between at least one of the employees and the directors between at least two registered vendors and the weight factors.

9. The vendor management method according to claim 7, further comprising a step of:
second accessing web data services by a web access device for gathering information related to the risk criteria of the registered vendors.

10. The vendor management method according to claim 9, wherein said step of accessing web data services further accesses legal history information, a Paydex score, and a commercial credit score of the registered vendors.

11. The vendor management method according to claim 7, wherein
the vendor management system is operated by an operating vendor, and the operating vendor is a registered vendor, said step of performing the risk analysis increases the risk score in case a relationship between at least one of the employees and the directors between a vendor and the operating vendor is detected.

12. The vendor management method according to claim 9, further comprising the step of:
triggering the risk analysis by the user with the user terminal, and
accessing the web data services by the web access device to update the information, upon said step of triggering.
